(19) United States
(12) Patent Application Publication
(10) Pub. No.: US 2013/0200626 A1
(43) Pub. Date: Aug. 8, 2013

(54) Wave Energy Converter and Transmission

(71) Applicants: Mikael Sidenmark, Karlskrona (SE); Torbjorn Andersson, Karlskrona (SE); Svante Logeke, Vaxjo (SE)

(72) Inventors: Mikael Sidenmark, Karlskrona (SE); Torbjorn Andersson, Karlskrona (SE); Svante Logeke, Vaxjo (SE)

(73) Assignee: OCEAN HARVESTING TECHNOLOGIES AB, Karlskrona (SE)

(21) Appl. No.: 13/639,557

(22) PCT Filed: Apr. 7, 2011
(86) PCT No.: PCT/SE11/50420

§ 371 Date: Nov. 27, 2012

(30) Foreign Application Priority Data
Apr. 7, 2010 (SE) 1000345-7
Dec. 7, 2010 (SE) 1001170-8

(51) Int. Cl. F03B 13/14; F16H 3/44

(52) U.S. Cl. CPC F03B 13/14; F16H 3/44
USPC 290/53; 60/504; 475/337; 475/312

(57) ABSTRACT

A wave energy converter includes a buoy and a power takeoff. A driveshaft in the power takeoff is driven to rotate by movements of the buoy and is mechanically coupled to an electric generator through a planetary gearbox and drives it for generating electric current at an even level, while storing excess energy in an energy accumulation device. The energy accumulation device is coupled to the generator through another part of the planetary gearbox for driving the generator during the other of the rising and sinking movements with continued torque, rotation speed and rotational direction. Major portions of the driveshaft can be located at a radial distance of the generator, allowing the generator and also components coupling the rotation of the portions of the driveshaft to the generator to be located in a sealed space, the only bearings that have to be sealed to the water being those that support said portions of the driveshaft. Also, the buoy can be divided in a front buoy and a rear buoy, the power takeoff including counterweight and anchor drums mounted in the front buoy. A counterweight constituting the accumulation device can then be suspended from a sheave mounted to the rear buoy.

### RELATED APPLICATIONS

This application claims priority and benefit from Swedish Patent Applications No. 1000345-7, filed Apr. 7, 2010, and No. 1001170-8, filed Dec. 7, 2010, the entire teachings of which are incorporated herein by reference. Furthermore, the present application discloses methods and devices based on or related or similar to those disclosed in Swedish Patent Applications Nos. 0800395-6 and 0802165-1 and published International Patent Application No. WO 2009/105011, the entire teachings of which are also incorporated herein by reference.

### TECHNICAL FIELD

The present invention relates to a wave energy converter for producing electric energy from movements of water waves, a method of producing electric energy from more or less intermittent mechanical energy, such as more or less periodical movements of a body, and to a power takeoff for wave energy converters to be used when such more or less intermittent mechanical energy is available and components for use in a wave energy converter or in a power takeoff for wave energy converters.

### BACKGROUND

Wave power has a large potential of becoming cost efficient since the energy density in ocean waves is very high, allowing small wave energy converters in relation to the capacity thereof. Furthermore, wave energy is more reliable and predictable than for instance wind energy since waves are built by the wind during a long period of time and then continue as well also after the wind has subsided. This results in slow variations in the average energy content of the waves, which gives system advantages when wave energy converters are connected to the general electric power distribution network.

However, there are great challenges that must be solved before wave power can be competitive to conventional power production. Survivability in the extreme conditions at sea often results in costly over-dimensioning. During storm conditions, the energy levels may become over a 100 times higher than normal and salt water causes heavy wear on the components. The wave motion is oscillating and has never ceasing variations in height, length and time period (velocity) from wave to wave at a given sea state, this giving large variations in the energy being absorbed by a wave energy converter and also requiring a great length of stroke to allow energy to be efficiently absorbed. For direct driven operation, i.e. when the generator in the wave energy converter is driven according to the momentary movement of the wave, this results in a low utilization of the power plant, i.e. the so called capacity factor takes a low value. The power of the generator shifts between zero and a top level twice every wave period. The top level may also change very strongly from wave to wave, this generating very high peak loads in the electrical system in relation to the average power output. The general electric power distribution network requires relatively stable levels, both in delivered power and voltage, this resulting in that the electric control systems for this kind of wave energy converters must, after the generation, make the levels of these quantities more even. This may in turn result in costly over-dimensioning of the total electrical system of wave energy converters and wave power farms in order to achieve a proper handling of the peak loads. The intermittent energy within a wave spectrum also causes extreme structural loads, which may result in costly over-dimensioning of the power takeoff Even though the state of the sea changes slowly, it changes strongly from time to time over the year. The sea-level may also strongly change because of winds and tides. The power takeoff must adjust to and be capable of handling these very dynamic conditions in order to absorb and convert energy from the waves in an efficient manner.

Wave power technologies have been developed for a long period of time but up to now it has not been possible to arrive at a method and a design of a wave energy converter, where it has been possible to combine the necessary properties as described above while keeping the complexity of the device at a low level.

A frequent method of capturing the energy of water waves is to use the vertical movement of the water. Installations that use such technology are sometimes called “point absorbers”. One method of using the vertical movements comprises the use of a buoy having a bottom foundation and an anchor wheel. The bottom foundation is firmly positioned on the sea-floor and is connected to the buoy which follows the ocean surface, i.e. the wave movements. When the surface rises and thereby lifts the buoy, a motive force is created which is converted to a rotational movement by a driving bar connected between the foundation and the buoy or by a wire or chain which runs over an anchor wheel journalled for rotation at the buoy or in the foundation and which is at an opposite end connected to the foundation or the buoy, respectively. The motive force increases due to the increased motion speed of the waves when the wave height becomes higher. The rotation direction and speed of an anchor wheel, if such a wheel is used, is directly dependent on the vertical direction and motion speed of the waves. However, this is not optimal for coupling a conventional generator to the anchor wheel to produce electric energy.

In order to make a wave energy converter driving a conventional rotating generator efficient, the vertical movements of the waves must be converted into a unidirectional rotational movement, and the rotation speed of an electric generator connected to the transmission must be stabilized. In a device, as described above, using a driving bar, wire or chain, which is secured to the bottom of the sea or in a frame structure and which runs along or over an anchor wheel journalled in a buoy, this problem can partly be solved in the following way. When the buoy is lifted by a wave, a motive force over the anchor wheel is produced. Thereupon, when the wave falls, an anti-reverse mechanism is disengaged and the anchor wheel is rotated backwards by a counterweight. Then, the motive driving is only active during the rise of the wave and completely ceases when the wave sinks, this not being satisfactory. Attempts have been made to reverse the rotation direction, so that an electric generator driven by the anchor wheel is driven by the counterweight in the same direction also when the wave sinks. It has also been attempted to reverse the rotation direction of the generator. However, changing the rotation direction of a mechanical transmission or of the generator twice in every wave period results in heavy mechanical wear. Even though the rotation direction can be made unidirectional by the transmission, the rotation speed follows the speed of the vertical movement, this causing the power output from the generator to vary according to the speed of the wave movements. This gives a low capacity factor and high attenuating effects since the mass of the generator all the time must alternately be accelerated and decelerated. In order to make the motive force and rotation speed of a generator more even using a mechanical transmission, multiple buoys can cooperate with each other, a phase shift then existing between the movements of the buoys. However, this only works optimally in the case where the buoys are evenly distributed over a wave period, which very seldom occurs since the length and the speed of the waves always vary. Also, the transmission system becomes more complex and hence hydraulic mechanisms are frequently used in systems of this type. However, hydraulic devices results in complex systems having large transmission losses.

Some of the basic disadvantages of the wave energy converters having the structure described above are eliminated or at least significantly reduced in the wave energy converters disclosed in the published International Patent Application No. WO 2009/105011. In such wave energy converters energy from water waves is in the common way, during parts of the movements of the water waves, absorbed for driving an electric generator. Part of the absorbed energy is temporarily accumulated or stored in some suitable mechanical way for driving the electric generator during other parts of the movements of the water waves. The driveshaft coupling of the movement of the water level and the mechanical energy storage to the electric generator is in a special mechanical way arranged for a unidirectional rotation with a constant torque and a constant rotation speed.

### SUMMARY

It is an object of the invention to provide an efficient wave energy converter.

In a wave energy converter energy from water waves in a pool of water is, during parts of the movements of the water waves, absorbed for driving an electric generator, the term “pool of water” herein taken to include any body or mass of water. Part of the absorbed energy is accumulated or stored for driving the electric generator during other parts of the movements of the water waves.

A driveshaft is mechanically arranged for a unidirectional rotation only, driven for example by the rising or sinking movements of a water surface.

A wave energy converter can generally include:
1. A buoy or other device arranged at or in a pool of water to be set into motion by movements of the water in the pool of water.
2. A driveshaft, which is rotatably journalled to the buoy or the other device, respectively, or to a device arranged to give a force counteracting the movements of the water in the pool of water.
3. A first elongated means such as a bar, line or wire, which both is coupled to a device arranged to give a force counteracting the movements of the water in the pool of water or to the buoy, respectively, and is coupled to the driveshaft.
4. An electric generator, which is coupled to the driveshaft and includes two parts that are rotatable in relation to each other, a first part and a second part, commonly called the rotor and the stator.
5. An energy accumulation device,
6. A planetary gearbox or some other suitable three-way mechanical gearbox mounted in the power transmission path between portions of the driveshaft, the electric generator and the energy accumulation device.

In the wave energy converter the driveshaft drives, for first movements of the buoy or the other device, the two parts of the electric generator to rotate in relation to each other in a first direction to generate electric current and also simultaneously supplies energy to the energy accumulation device, and for second movements, the energy accumulation device drives the two parts of the electric generator to rotate in the same first direction to generate electric current.

The gearbox has incoming and outgoing shafts which, such as is the case for planetary gearboxes, are aligned and/or concentric with each other. These incoming and outgoing shafts can in such a wave energy converter be located at a radial distance from portions of the driveshaft, e.g. the gearbox can be mounted so that its incoming and outgoing shafts are not concentric, coaxial or aligned with the portions of the driveshaft which are directly coupled to the first elongated means and the incoming and outgoing shafts can additionally or alternatively be located at radial distance of a shaft of the energy accumulation device such as in the case where it comprises a counterweight and counterweight drum having a shaft, e.g. the incoming and outgoing shafts are not concentric or aligned with a rotation axis of the energy accumulation device. The shaft of the electric generator can generally be aligned with the rotation axis of the incoming and outgoing shafts of the gearbox, e.g. directly coupled to an outgoing shaft thereof. The shaft of the electric generator can generally be located at a radial distance from said portions of the driveshaft and/or from a shaft of the energy accumulation device. Such a design allows a gearbox, such as a planetary gearbox, and also the electric generator to be mounted in a closed or sealed space/closed or sealed spaces, these closed or sealed spaces having no wall that has, in operation of the wave energy converter, any openings arranged to or intended for facing the water or the external air except the openings for the driveshaft that are provided with proper shaft seals that come in contact with the water and possibly openings for shafts of other devices that has to face or be immersed in the water such as a counterweight drum included in the energy accumulation device.

Specifically, in the power takeoff of the wave power converter including the driveshaft, the first elongated means, the energy accumulation device and the electric generator, the first elongated means being flexible and coupled to a winding drum connected to the driveshaft, all components of the power takeoff apart from drums, line tracking devices and a portion or portions of the drum shafts can thus be mounted in the closed or sealed space.

The driveshaft may be split so that a first portion thereof is coupled to the first elongated means and a second portion of the driveshaft is coupled to the energy accumulation device. The first and second portions may be supported by sealed bearings mounted in the encapsulating walls of the sealed spaces and they may also have parts passing into one or more of these spaces. The first and second portions can also be mounted at a radial distance of each other or they can be concentric so that e.g. the second portion is hollow and encloses a region of the first portion. The portions of the driveshaft are then mechanically coupled to each other by some suitable mechanical transmission such as a belt, chain or gear drive so that they rotate synchronously.

When the wave energy is in use, the first portion of the driveshaft then drives, for first movements of the buoy or the other device, the first gearbox shaft to rotate and thereby to drive, through the three-way gearbox, also the second and third gearbox shafts to rotate, thereby rotating the two parts of the electric generator in relation to each other in a first direction to generate electric current and also rotating the second portion of the driveshaft to supply energy to the energy accumulation device that stores the energy. The energy accumulation device drives, for second movements of the buoy or the other device, the second portion of the driveshaft to rotate and thereby, by the coupling of the second portion to the second gearbox shaft and therefrom, through the three-way gearbox, to the third gearbox shaft, the two parts of the electric generator to rotate in the same first direction to generate electric current.

A first portion of the driveshaft that is coupled to the first elongated means, such as by an anchor drum to a flexible means, e.g. an anchor line, anchor cable or anchor wire, can be located in a space or recess that is at least open downwards, towards the water or even more or less immersed in the water. In the case where an anchor drum is used, it is then also located in the same space or recess. In the case where the energy accumulation device comprises a counterweight that is located in the water and is suspended in a counterweight line, cable or wire from the buoy, a counterweight drum from which the counterweight line, cable or wire is directly suspended and around which it is more or less wound can also be located in the same space or recess, e.g. having it rotation axis in parallel with the axis of the first portion of the driveshaft. The more delicate components of the power train or power takeoff of the wave energy converter, such as the gearbox and the electric generator can then be located in a sealed or closed space or room that e.g. is located at a level above the first portion of the driveshaft and the anchor drum and the counterweight drum if such devices are used. For example, the space or recess may be defined by two vertical, facing, opposite and parallel walls in which said shafts are mounted in sealed bearings for rotation. A gearbox assembly can then be mounted directly above said space or recess, having its incoming and outgoing shafts in parallel with the other shafts, these shafts e.g. supported by prolonged portions of said facing walls. A second portion of the driveshaft may then be connected to and aligned with an incoming shaft of the gearbox assembly. An outgoing shaft of the gearbox assembly can be rigidly connected to the shaft of the electric generator.

Generally thus, a wave energy converter can comprise a driveshaft portion mounted to be rotated for movements of the water when the wave energy converter is arranged for use in a pool of water, an electric generator, an energy accumulation device, and a three-way gearbox such as a planetary gearbox. The three-way gearbox is mounted in a transmission path between the driveshaft portion, the electric generator and the energy accumulation device. The driveshaft portion is coupled to a first of the gearbox shafts, the energy accumulation device is coupled to a second of the gearbox shafts and the electric generator is coupled to a third of the gearbox shafts. The first and second ones of the gearbox can in particular be located at two opposite sides or ends of the gearbox, the first one located at a first side or end and the second one at an opposite, second side or end thereof

The couplings to the gearbox shafts can be arranged so that at least the three-way gearbox and the electric generator are located in a stationary, sealed and closed space.

Alternatively or additionally, the couplings to the gearbox shafts can be arranged so that the three-way gearbox and the electric generator are located at a radial distance of the driveshaft portion.

Either or both of these alternatives can be allowed by arranging the coupling of the driveshaft portion to the first gearbox shaft at a first side or end of the three-way gearbox and the coupling of the energy accumulation device portion to the second gearbox shaft at a second, opposite side or end of the three-way gearbox.

Either or both of these alternatives can be allowed by providing a first belt, chain or gear drive connecting the driveshaft portion to the first gearbox shaft and a second belt, chain or gear drive connecting the energy accumulation device to the second gearbox shaft, the first belt, chain or gear drive arranged at a first side or end of the three-way gearbox and the second belt, chain or gear drive arranged at an opposite, second side or end of the three-way gearbox.

The driveshaft portion can, in order to be rotated for movements of water, be attached to a winding drum coupled to first elongated means. Another portion, a second portion, of the driveshaft can be coupled to the energy accumulation device and in particular to another winding drum. The two driveshaft portions can then be mounted at a radial distance of each other. They can extend between two opposite parallel shaft support walls, a central space then being defined between the two shaft support walls which is open towards the water when the wave energy converter is used. Inner closed or sealed spaces can then be defined behind the opposite sides of the shaft support walls and another closed or sealed space can be provided directly above the open space and it can house the three-way gearbox.

The three-way gearbox can be comprised in a gearbox assembly also comprising a sliding clutch for overload protection and/or one or two anti-reverse mechanisms.

In the case where the three-way gearbox is a planetary gearbox it can be comprised in a gearbox assembly also comprising means for keeping a flexible means such as an anchor wire tensed, the flexible means connected to the first mentioned shaft portion. Such means can comprise a modified planetary gearbox having two ring gears and two sun gears cooperating with planet wheels on a single planet holder or two ordinary planetary gearboxes having their planet holders rigidly connected to each other.

In another case, the first portion of the driveshaft can be concentrically mounted, the second portion being hollow and enclosing a region of the first portion.

According to an alternative, independent aspect of the wave energy converter, which can be adapted for use also in other arrangements of the driveshaft and of the other various components of the wave energy converter, the power takeoff is modified so that the anchor wire can be fed between parts of the anchor drum, i.e. so that the portion of the anchor wire that is in normal operation wound around and unwound from the anchor drum can be changed or shifted to another portion of the anchor wire. Such a design may significantly extend the life of the anchor line and/or allow the use of an anchor drum and an anchor line having a smaller diameter. A similar design can be used for the counterweight drum.

Such an embodiment including a split anchor drum can be used in general mooring or anchoring systems, e.g. for offshore platforms, oil platforms or oil rigs, in order to reduce the wear and fatigue on the mooring or anchoring lines or wires. In such a mooring or anchoring system each of the anchoring lines is commonly partly wound around an anchoring drum and the anchoring line is kept properly tensed by a motor acting on the anchoring drum. Then this anchoring drum can be divided in two parts, e.g. arranged to rotate around the same rotational axis, each of the two parts driven by an own motor. Specifically, the two parts of the anchoring drum comprises may then be arranged to rotate independently of each other. Each of the two parts of the anchoring drums is coupled to an own tensing or return feeding motor, e.g. an electric motor. The anchoring line comprises an upper part, the end portions of which are more or less wound around a separate one of the two anchoring drum parts. The anchoring lines further comprises a bottom part that is attached or secured to the bottom of the pool of water. A running sheave is attached to the upper end of the bottom part of the anchoring line and the upper part of the anchoring line is running over this sheave.

In the case where the three-way gearbox is modified to provide return feeding capabilities, the two mentioned motors for return feeding are not needed. They can be replaced by one disc brake on either one or both of the two parts of the divided anchor or counterweight drum which are arranged to rotate around the same rotational axis. If one disc brake is locked during return feeding, wire will shift from one of the drums to the other one. During forward feeding, the brake or brakes are unlocked, allowing even distribution of motive force from the two parts of the respective drum to the same shaft.

According to another independent aspect of the wave energy converter, the buoy is split in two element buoys connected to each other, a front element buoy and a rear element buoy. Such a wave energy converter can then generally include:
a buoy arranged at or in a pool of water to be set into motion by movements of the water in the pool of water,
a driveshaft, which is rotatably mounted to the buoy or the other device, respectively, or to a device arranged to give a force counteracting the movements of the water in the pool of water,
a first elongated means, which both is coupled to a device arranged to give a force counteracting the movements of the water in the pool of water or to the buoy, respectively, and is coupled to the driveshaft,
an electric generator, which is coupled to the driveshaft and includes two parts that are rotatable in relation to each other, a first part and a second part, and
an energy accumulation device including a counterweight and coupled to the driveshaft.

The first elongated means then extends from the front element buoy where the driveshaft is mounted and the counterweight is suspended from the rear element buoy. The counterweight is suspended in a counterweight line and the counterweight line can then extend from the counterweight over a sheave or break wheel which is rotatably mounted in the rear element buoy and therefrom to the front element buoy. The front and rear element buoys may be rigidly connected to each other or alternatively, the rear element buoy can be hinged to the front element buoy. Both designs can allow the rear element buoy to move in a vertical direction in relation to the front buoy while it is maintained from moving in a horizontal direction in relation to the front buoy, such as by arranging an intermediate part. The intermediate part can be stiff and at one end connected to or articulated at the front element buoy and at the opposite end connected to or articulated at the rear element buoy. As above the first elongated means can comprise an anchor line, the anchor line then extending from the drive shaft over a sheave or break wheel, which is rotatably mounted in the front element buoy in front of the drive shaft, and therefrom extending to the bottom of the pool of water.

Additional objects and advantages of the invention will be set forth in the description which follows, and in part will be obvious from the description, or may be learned by practice of the invention. The objects and advantages of the invention may be realized and obtained by means of the methods, processes, instrumentalities and combinations particularly pointed out in the appended claims.

### BRIEF DESCRIPTION OF THE DRAWINGS

While the novel features of the invention are set forth with particularly in the appended claims, a complete understanding of the invention, both as to organization and content, and of the above and other features thereof may be gained from and the invention will be better appreciated from a consideration of the following detailed description of non-limiting embodiments presented hereinbelow with reference to the accompanying drawings, in which:

FIG. 1a is a schematic view of a transmission housing for a wave energy converter as seen from above, the view being taken partly along a horizontal sectional plane,

FIG. 1b is a schematic sectional view of the transmission housing of FIG. 1a as seen from the front,

FIG. 1c is a schematic sectional view of the transmission housing of FIG. 1a as seen from the side,

FIG. 1d is a detail view of a gearbox assembly together with an electric generator being part of the transmission housing of FIG. 1a,

FIG. 1e is a schematic sectional view of the transmission housing of FIG. 1a including a mechanism for shifting an anchor wire between two anchor drums, as seen from the front,

FIG. 1f is a schematic sectional view in a larger scale of the transmission mechanism of the transmission housing of FIG. 1e,

FIG. 1g is similar to FIG. 1f of the transmission housing comprising a modified wire shifting mechanism working in combination with the return feeding mechanism of FIG. 9b,

FIG. 1h is similar to FIG. 1g but for a wire shifting mechanism for the counterweight drum,

FIG. 1i is a principle view of a wire shifting mechanism,

FIG. 2a is a view from below of a buoy included in a wave energy converter in which the transmission housing of FIG. 1a can be used,

FIG. 2b is a view from the side of the buoy of FIG. 2a,

FIG. 2c is view of a wave energy converter in which the buoy of FIGS. 2a and 2c is used,

FIG. 3a is a view of a wave energy converter including the transmission housing of FIG. 1a mounted to a submerged body positioned below a buoy and including a heave plate to counteract the movements of the buoy at the water surface,

FIG. 3b is a view similar to FIG. 3a of a wave energy converter of in which the submerged body is anchored to the seafloor by constant tension mooring lines to counteract the movements of a buoy at the surface,

FIG. 4a is a schematic similar to FIG. 1a of an alternative embodiment of the transmission housing having two anchor drums,

FIG. 4b is a view similar to FIG. 4 also showing a buoy having a shape that may be suitable in some cases,

FIG. 5 is a view of a counterweight having a ballast tank,

FIG. 6 is a schematic of a wave energy converter according to prior art comprising four separate wave energy converters,

FIG. 7 is a sectional view of a wave energy converter according to prior art having a power train including a counterweight,

FIG. 8a is a schematic of a device according to prior art for driving an electric generator both when a buoy is rising and sinking, the generator having a rotating stator, and

FIG. 8b is a view from a different side of the device of FIG. 8a,

FIG. 8c is a schematic similar to FIG. 8a a device according to prior art for driving an electric generator both when a buoy is rising and sinking, the device including a planetary gearbox and the generator having a stationary stator, and

FIG. 8d is a view similar to FIG. 8b, the view seen from a different side of the device of FIG. 8c,

FIG. 9a is a sectional schematic view of a modified gearbox assembly including a return feeding mechanism,

FIG. 9b is similar to FIG. 9a but using a clutch instead of an electrically operated freewheel or antireverse mechanism,

FIGS. 9c and 9d are schematic sectional views of alternative embodiments of a special planetary gearbox used in the modified gearbox assembly of FIGS. 9a and 9b,

FIG. 9e is a sectional schematic view of a first stage of the special planetary gearbox of FIG. 9d used for return feeding, and

FIGS. 10a and 10b are schematic views from the bottom and from the side, respectively, of an alternative embodiment of a buoy.

### DETAILED DESCRIPTION

First, a wave power farm and wave energy converters comprised therein and the function thereof, as disclosed in the cited International Patent Application No. WO 2009/105011, will be briefly described.

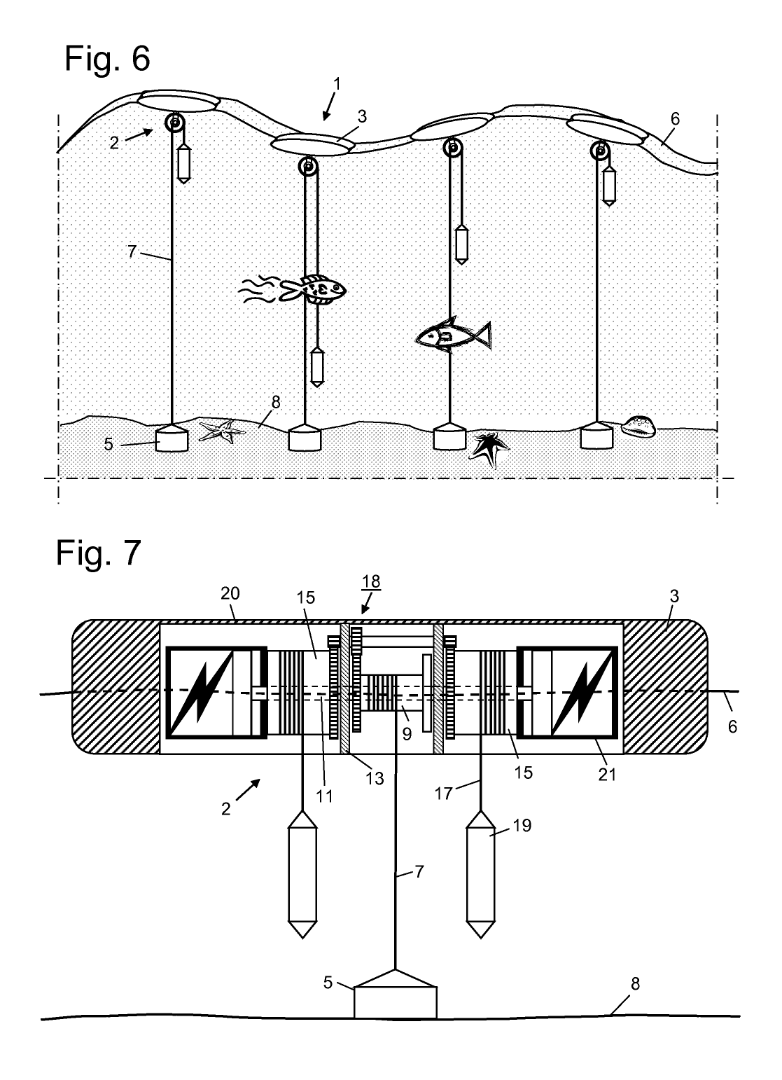

In FIG. 6 a wave power farm for producing energy from the movements of waves at a water surface 6 of a pool of water, e.g. movements of the water of an ocean, is shown. The wave power farm comprises one or more wave energy converters 1, each including a buoy or a floating body 3, which is located at the water surface 6, e.g. floating thereon, and which to a higher or lower degree follows the movements of the waves. In the upward and downward movements of the water surface the buoy is made to alternately rise or sink and/or to alternately rock or to tilt back and forth. Thereby a motive force can be created, in the case shown in relation to the bottom 8 of the water pool, such as a part rigidly attached to the bottom, e.g. a bottom foundation 5, which can have a mass large enough to keep it steadily on the bottom. If required, the bottom foundation can of course be attached to the bottom in some way and it may then comprise a simple fastening device having a relatively low mass, not shown. As can be better seen in FIG. 7 the buoy 3 and the bottom foundation 5—alternatively the bottom fastening device—are connected to each other by an anchor line 7, e.g. a wire of a suitable material such as steel. As an alternative, the motive force can be created in relation to some kind of movable object having a relatively large mass or added mass or generally to an object having a sufficient resistance to move such as to a weight or a heave plate, not shown, suspended in the buoy 3.

In the shown embodiment the anchor line 7 is at one end attached to the bottom foundation 5 and is at its opposite end attached to a power train or power takeoff 2 and more or less wound around a first winding drum, an anchor drum 9, included in the power train, the winding drum being mounted to rotate about a driveshaft 11. The driveshaft 11 is in a suitable way journalled for rotation at the buoy 3. On the driveshaft also at least one second winding drum, a counterweight drum 15, is arranged on which a counterweight line 17 is partly wound at its upper end. The counterweight line 17 carries at its lower end a counterweight 19. The rotation of the anchor drum 9 is coupled to the rotation of the counterweight drum 15 by some suitable transmission such as a gear transmission indicated at 18,

The power train 2 can be mounted in a transmission housing 20 formed in a recess in the buoy 3, also called a power train room. Then, the driveshaft 11 can e.g. be mounted in a substantially central position in the buoy. Support bars 13 can be attached to walls of the transmission housing 20.

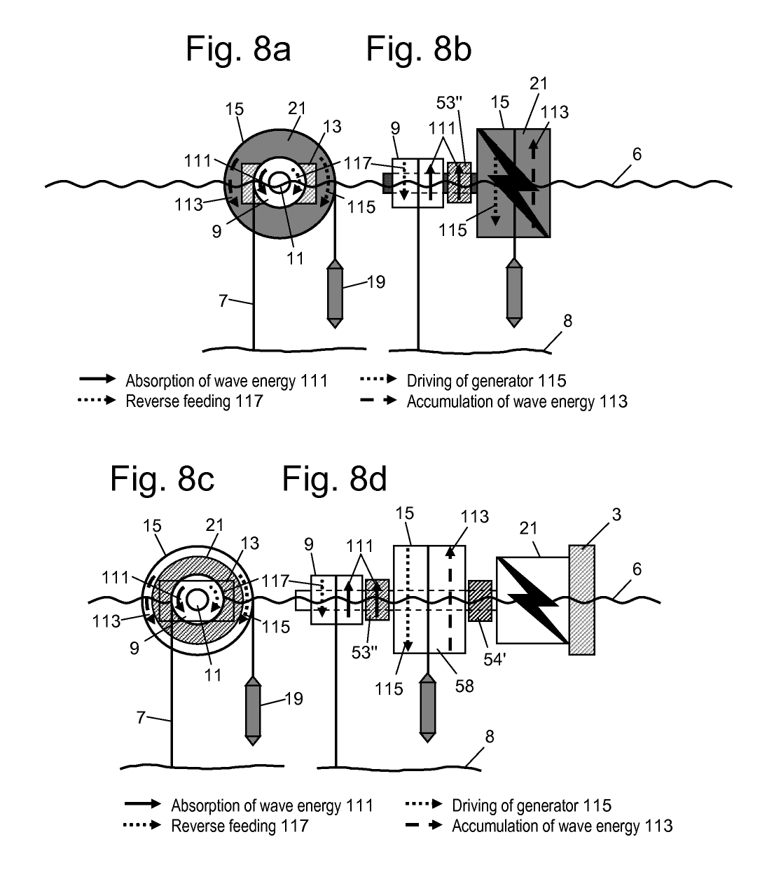

Thus, the anchor line 7 and the counterweight 19 are not directly connected to each other as in previously known constructions. Instead, as appears from FIGS. 8a and 8b, the electric generator 21 can be connected to be driven between the counterweight 19 and the anchor drum 9, so that e.g. a first part of the generator, not shown, typically corresponding to the inner rotating part, the rotor, of a conventionally mounted generator, on one side of the air gap of the generator, not shown, is mechanically connected to the anchor drum and a second part of the generator, not shown, typically corresponding to the outer stationary part of the generator, the stator, in a conventionally mounted generator, on the other side of the air gap, is mechanically connected to the movements of the counterweight, so that this part can also rotate. Hereby the generator 21 can be driven from two sides with a maintained relative rotation direction between its first part and its second part. When the wave and the buoy 3 are rising, the driveshaft 11 is rotated forwards by the anchor line 7, which runs around the driveshaft via the anchor drum 9 and which at its other end is anchored to the bottom 8, e.g. to a foundation 5. The counterweight 19 is used to create a resilient resisting force and thereby gives an even torque between the counterweight drum 15 and the driveshaft 11, which in that way drives the first part and second part of the generator 21 in relation to each other. It is also possible to use other power accumulation devices or other methods to achieve such a driving operation, e.g. a gas pressure or a spring for providing a constant force, as will be described below. When the wave and the buoy 3 are sinking, the driveshaft 11 is blocked from rotating backwards by return blocking mechanisms such as 53″, while the counterweight 19 or an energy accumulation device of some other type continues to drive the generator 21 using previously stored energy. Antireverse mechanisms such as the mechanisms 53″ or 54′ may be necessary in order to obtain the desired function. Also, some device for maintaining the tension in the anchoring line 7 by turning the anchor drum in the reversed direction may be required. Such a device can include e.g. an electric motor, as will be described below, a special gearbox design as will also be described below, an extra counterweight or an elastic mechanism or a spring mechanism.

In FIGS. 8a and 8b the arrows 111 show absorption of wave energy. The absorption level varies according to the momentary movement and the momentary movement direction of the wave. When the driveshaft 11 is rotated forwards by the anchor drum 9, also the generator 21 follows the rotation, so that the counterweight line 17 starts to be wound around the counter weight drum 15, which can be a part of or be rigidly attached to the second part of the generator, see the arrows 113, and so that the counterweight 19 is moved upwards. Hereby, potential energy is stored in the counterweight at the same time as a torque over the generator 21 appears. The torque makes the second part of the generator start rotating in relation to the first part, the latter part being mechanically connected to the driveshaft 11, so that the counterweight line 17 starts to unwind from the counterweight drum 15, and hereby potential energy accumulated in the counterweight 19 is converted to electricity, see the arrows 115. The faster the generator parts rotate in relation to each other, the more electric power is generated, and then also a higher counteracting force is obtained in the generator 21, i.e. the electromagnetic coupling between the two parts of the generator becomes stronger. When the counterweight 19 reaches a certain velocity, the pulling force from the counterweight becomes equal to the counteracting force in the generator, this resulting in the fact that the rotation speed of the generator and the power output from the generator 21 are stabilized in an equilibrium state. The arrows 117 show the reverse feeding of the anchor drum 9 when the buoy is sinking.

In FIGS. 8c and 8d it is in the same way as in FIGS. 8a and 8d schematically illustrated how the driving of the generator 21 can be achieved for a generator having a stator that is rigidly attached to the buoy 3. In this case a planetary gearbox 58 is used, a first shaft of which such as the shaft of the ring gear, not shown, is connected to the rotation of the counterweight drum 15, e.g. so that the gearbox is located inside it as shown and thereby the ring gear is firmly attached to the counterweight drum, or by a suitable drive. A second shaft, not shown, such as the shaft of the planet carrier of the planetary gearbox is connected to the rotation of the anchor drum 9 and the shaft of the sun gear, not shown, is connected to the electric generator 21. Gearboxes of other types can be used in a similar way so that they work as three-way gearboxes. Then, e.g. the casing or the cover of such a gearbox can be connected to the rotation of the counterweight drum 15. In that case, the house or casing of the three-way gearbox corresponds to the ring gear of the planetary gearbox. The driveshaft 11 includes as illustrated one part coupled to the anchor drum 9 for driving the second shaft of the gearbox and another part coupled to the counterweight drum for driving the first shaft of the gearbox and also for allowing the first shaft thereof to drive the counterweight 19 in order to store energy.

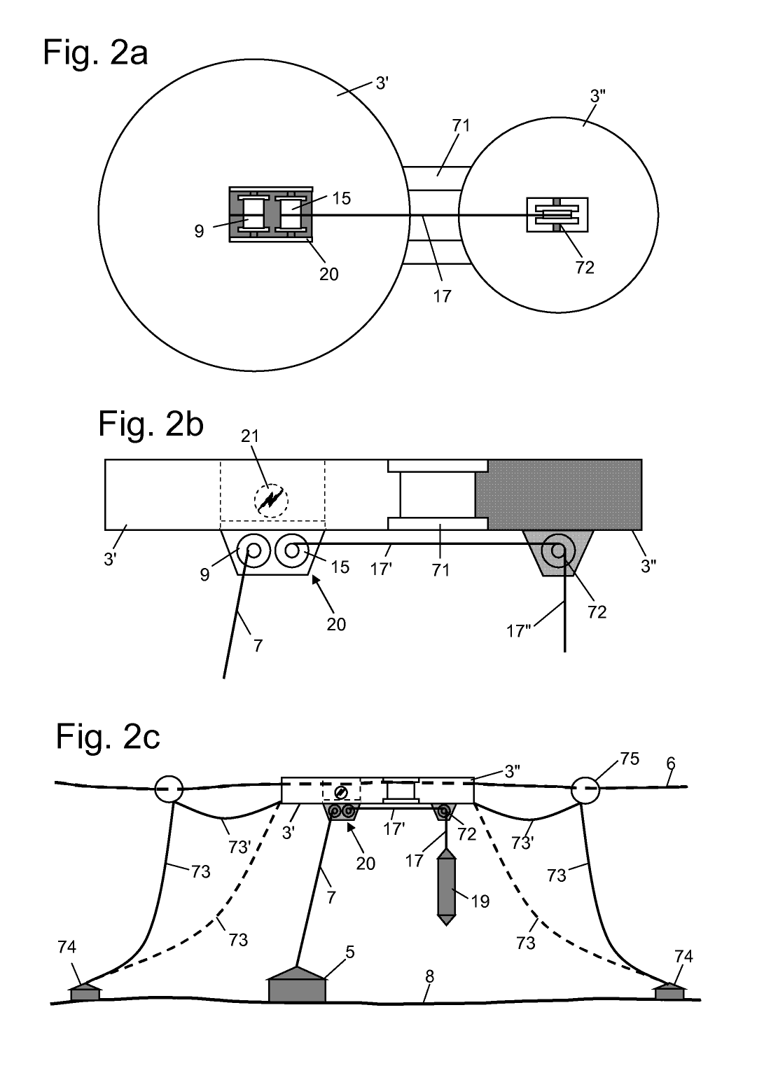

In the design of the wave energy converter 2 as seen in FIG. 7 and in the cited International Patent Application No. WO 2009/105011 the driveshaft 11 is generally made in one piece being selectively coupled to the rotation of the anchor drum 9 and the counterweight drum or drums 15 for driving the electric generator 21. All drums 9, 15 have the same rotation axis as the driveshaft and may thus selectively rotate around it and otherwise be attached to it for rotating together with the driveshaft. A planetary gearbox 58 such as that described with reference to FIGS. 8c and 8d is located inside each of the counterweight drums 15 whereas the associated electric generators 21 in this case can be placed in own closed spaces, see FIG. 2g of the cited International Patent Application.

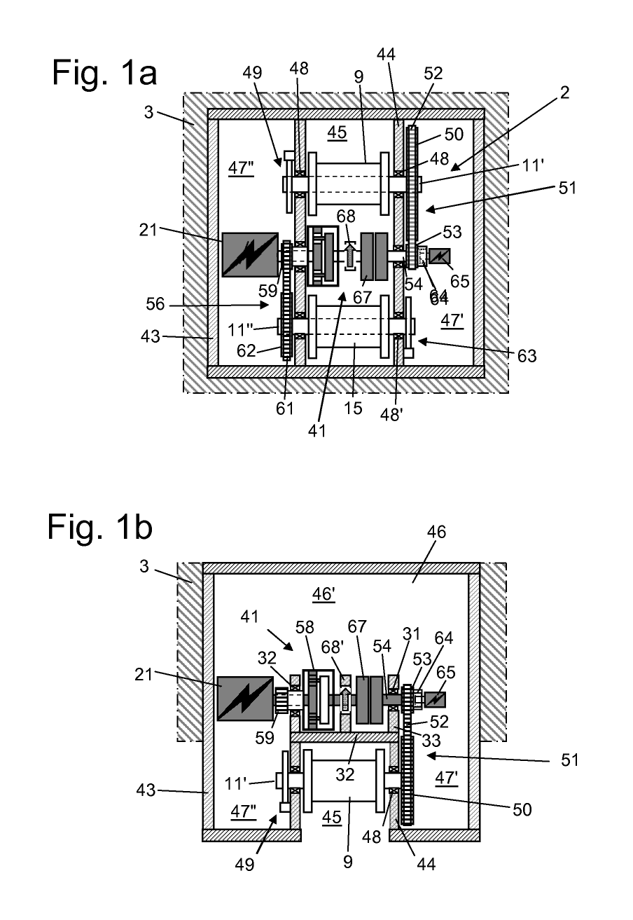

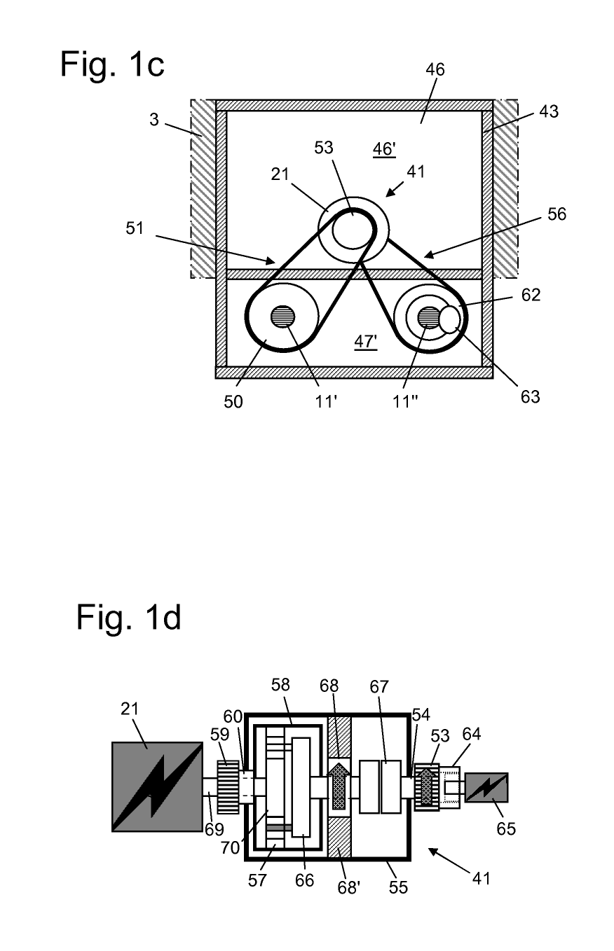

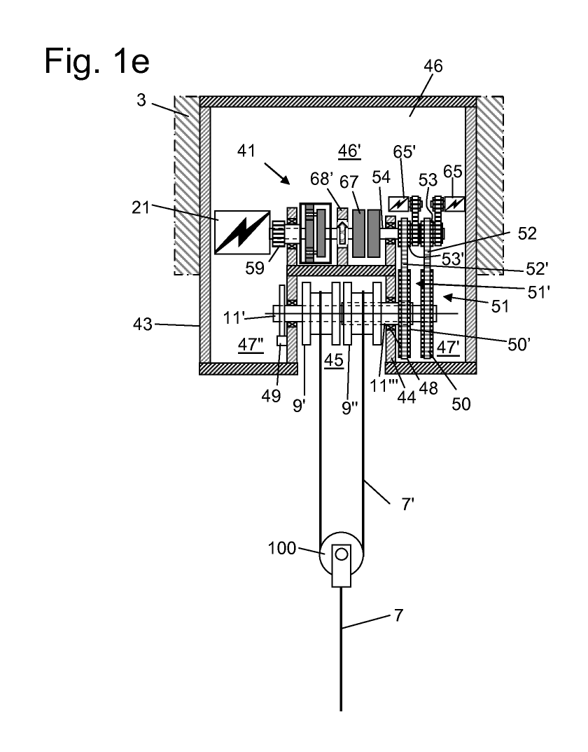

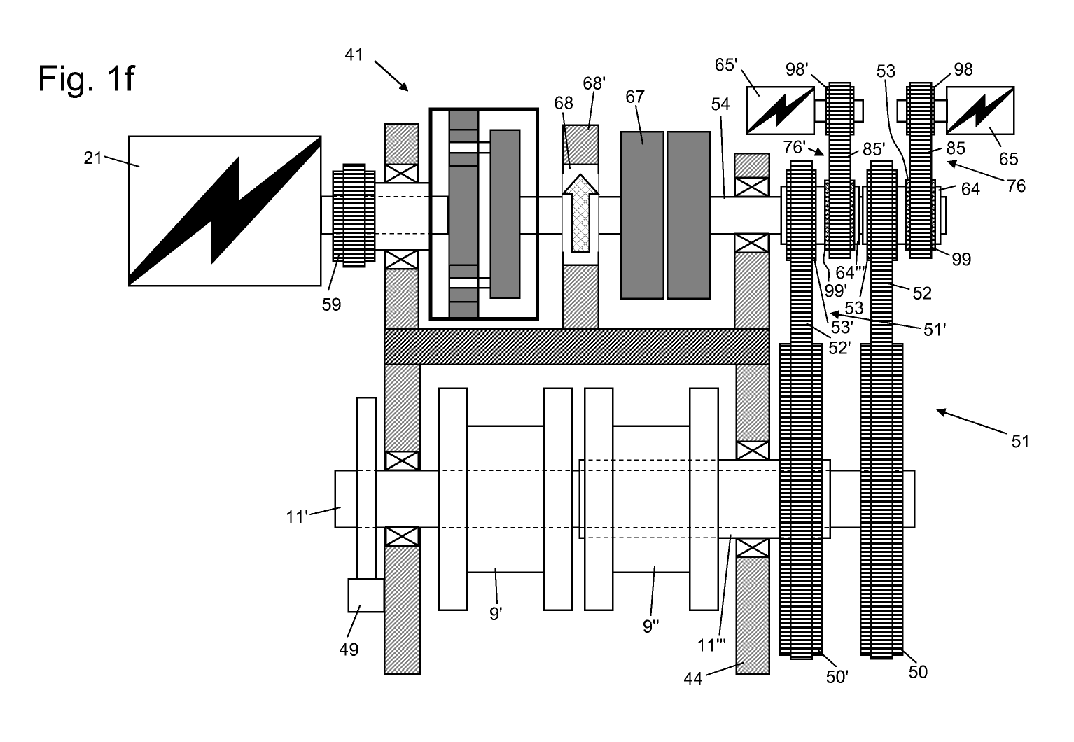

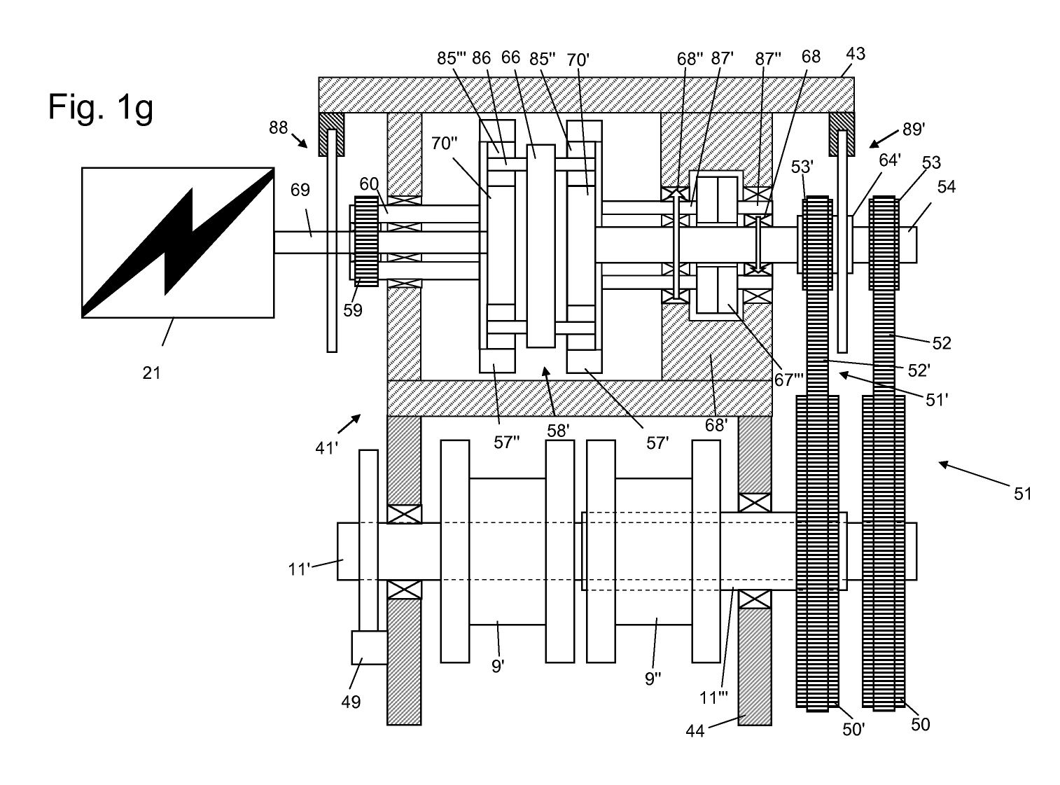

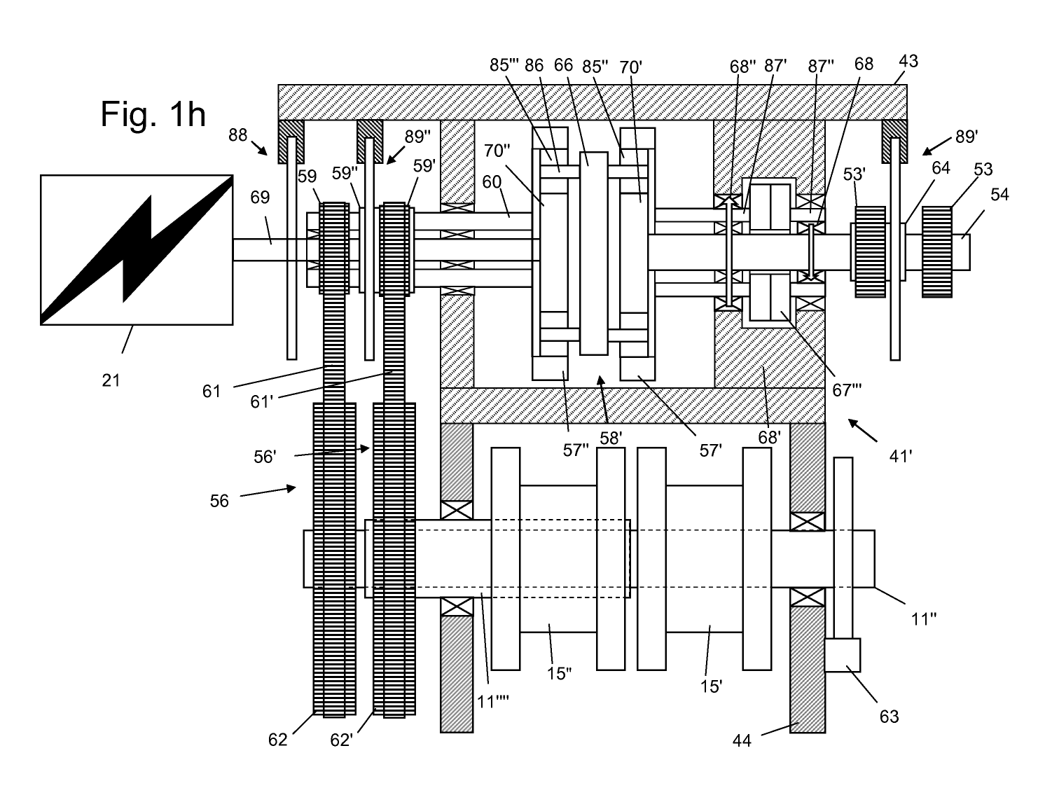

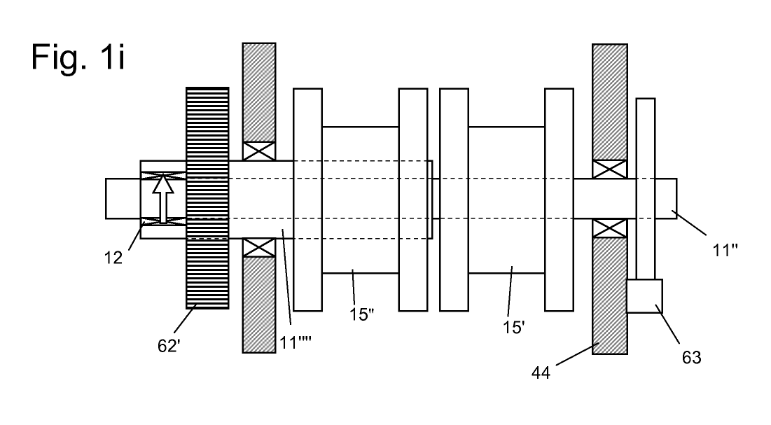

In FIGS. 1a, 1b and 1c an alternative system layout of the transmission or power takeoff 2 and the transmission housing 20 is shown. The function of the alternative system is basically the same as in the systems briefly described above with reference to FIGS. 8c and 8d and in the cited International Patent Application No. WO 2009/105011 but the alternative system is significantly simplified and may thus include a reduced number of components, have reduced torques acting on the transmission components, a reduced size of the transmission housing 20 and consequently a lower cost. The power takeoff 2 including the anchor drum 9, the driveshaft 11, the counterweight drum 15, a gearbox assembly 41 and the generator 21 are carried by a support housing 43, also called a support frame, that is secured to the buoy 3. In the support housing a recess 45 is formed that is open downwards, towards the bottom 8 of the water pool. The recess is formed between two parallel shaft support walls 44 which can extend between two opposite outer walls of the surrounding support housing 43. The recess 45 can be located centrally in the support housing. In the support housing 43 a closed or sealed inner space 46 is defined that can include an upper portion 46′ located at the top of the support housing and thus is located partly straight above the recess 45, i.e. above the drums 9 and 15, and first and second side spaces 47′, 47″ located interior of and laterally of the shaft support walls 44.

Only one anchor drum 9 is used and it is rigidly attached to a first part 11′, called an anchor drum shaft, of the driveshaft 11 that is divided into two parts. The anchor drum shaft 11′ is mounted for rotation in the shaft supports 44 using only two bearings 48 and thus extends between said shaft supports having its central portion carrying the anchor drum 9 located in the central open space 45. The ends of the anchor drum shaft 11′ extend into the side spaces 47′, 47″. At one end of the anchor drum shaft 11′, in the figure at the left side, a disc brake or drum brake or other braking or locking mechanism 49 is installed which is located in the second side space 47″ and is used for locking the anchor drum shaft during service. At the opposite end of the anchor drum shaft 11′, in the figure at the right side, a belt, chain or gear wheel 50 is rigidly mounted that is a component of a first belt, chain or gear drive 51. The first belt, chain or gear drive is completely located in the sealed space 46 and further includes a belt or chain 52 and another belt, chain or gear wheel 53 mounted to rotate around an input first shaft 54 of the gearbox assembly 41, being selectively attached to this first shaft by a first freewheel or anti-reverse mechanism 64 such as for rotation in one direction. The first belt, chain or gear drive 51 thereby connects the rotation of the anchor drum shaft 11′ to the rotation of the first input shaft 54 of the gearbox assembly.

The first belt, chain or gear drive 51 connecting the anchor drum shaft 11′ to the first input shaft 54 of the gearbox assembly 41 has a rotation speed increasing ratio of e.g. more than 1:2, typically 1:5, this resulting in relatively large rotation speeds of the shafts of the gearbox 58. The torque on the gearbox components is reduced by the same ratio, this allowing them to be smaller and/or lighter compared to the designs disclosed in the cited International Patent Application No. WO 2009/105011.

The gearbox assembly 41 includes the gearbox 58 and has its input first shaft 54 located at one side or end and at the opposite side or end it has two other shafts, a combined input and output second shaft 60 to be driven by the energy accumulation device such as the counterweight drum 19 through the belt or gear transmission 56 and an output third shaft 69 rigidly connected to the rotatable part of the electric generator 21. The input/output second shaft 60 is hollow, the output third shaft 69 passing therethrough. The gearbox assembly also comprises a second freewheel or anti-reverse mechanism 68 mounted to act between the input first shaft 54 and the input first shaft of the planetary gearbox 58. Furthermore, a coupling 67 such as a sliding clutch or similar device can be comprised in the gearbox assembly and mounted in the input first shaft 54 to selectively attach the two portions thereof to one another.

All said shafts 54, 60, 69 of the gearbox assembly 41 are coaxial or aligned with each other as well as with incoming and outgoing shafts of the three-way gearbox 58 and the shaft of the second freewheel or anti-reverse mechanism 68 and the shaft of the coupling 67. The input shafts 54, 69 of the gearbox assembly are supported by bearings 31, 32 mounted in support walls 33 attached to the support housing 43. These support walls can be prolongations of the opposite shaft support walls 44, which in turn can be connected to each other by another wall 34 forming a roof of the recess or space 45. Alternatively the support walls 33 for the input shafts 54, 60 can project from said interconnecting wall 34.

At the other side of the gearbox assembly 41, a second belt, chain or gear drive 56 is 10 provided that connects the ring gear 57 of the planetary gearbox 58 included in the gearbox assembly 41 to a second part 11″ of the drive shaft 11, the counterweight drum shaft, see also FIG. 1b. The counterweight drum shaft is journalled for rotation in the shaft supports 44 using two bearings 48′ and extends between the shaft support walls 44 and has its central portion carrying the counterweight drum 15 located in the recess 45. The ends of the counterweight drum shaft 11″ extend into the side spaces 47′, 47″.

The second belt, chain or gear drive 56 is also completely located in the sealed space 46 and includes a belt, chain or gear wheel 59 rigidly mounted to the second input/output shaft 60 of the gearbox assembly 41 that is in turn rigidly connected to the ring gear 57 of the planetary gearbox 58, a belt or chain 61 and a belt, chain or gear wheel 62 rigidly mounted to an end of the counterweight drum shaft 11″, in the figure to the left end thereof.

The movement speed of the counterweight 19 can be controlled by setting the ratio of this second belt, chain or gear drive 56, instead of using a different diameter of the counterweight drum 15 as proposed in the prior art. Typically, a rotation speed increasing ratio of 1:2.5 can be used in the second belt, chain or gear drive 56, i.e. the rotation speed of the input/output second shaft 60 of the gearbox assembly 41 may be 2.5 times higher than the rotation speed of the counterweight drum 15. In the same way the first belt drive 51 can have a rotation speed increasing ratio of 1:5, i.e. the rotation speed of input first shaft 54 of the gearbox assembly 41 is in a driving situation 5 times higher than the rotation speed of the anchor drum 9. This will increase the movement speed of the counterweight 19 and thereby reduce the weight thereof needed to achieve the same motive force, by a factor of 2. Generally, the ratios of the belt, chain or gear drives can be set so that if the second drive 56 increases the rotation speed from the counterweight drum 21 to the gearbox assembly 41 by a factor n, the first belt, chain or gear drive 51 increases the rotation speed from the anchor drum 9 to the gearbox assembly 41 by a higher factor, such as by a factor in the range of 1.5·n to 3·n and specifically by a factor of 2·n. Of course, also in some case the two drives may be operating at the same or equal ratio. At the left end of the counterweight drum shaft 11″, a disc brake or drum brake or similar braking device 63 is provided which is located completely in the sealed space 46 and is used to lock the counterweight drum shaft and thereby the counterweight 19 during service, standby and failure mode.

The function of the system will now be briefly described. When a wave is lifting the buoy 3, the anchor drum 9 and the anchor drum shaft 11′ are rotating and then the first freewheel or antireverse mechanism 64 mounted to act between the belt, chain or gear wheel 53 and the input first shaft 54 of the gearbox assembly 41 is locked or engaged, so that the input first shaft 54 is rotated. The second freewheel or anti-reverse mechanism 68, see FIG. 1d, that is mounted to act between a support 68′ rigidly attached to the support housing 43, such as to the interconnecting support wall 34, and the input first shaft 54 is then disengaged. The support 68′ can be a support wall e.g. parallel to the support walls 33 for the bearings of the shafts of the gearbox assembly 41. It allows the first input first shaft 54 which is rotating forwards to drive the planetary holder 66 of the planetary-way gearbox 58. A portion of the torque on or of rotation of the planetary holder is transferred to the sun gear 70 driving the generator 21 through the output shaft 69. Another portion of the torque on or of rotation of the planetary holder 66 is transferred to the ring gear 57 of the gearbox 58, thereby driving the input/output shaft 60 to rotate and thus store energy by rotating the second portion 11″ of the driveshaft through the second belt, chain or gear drive 56 to lift the counterweight 19.

When the wave sinks, the first freewheel or anti-reverse mechanism 64 is disengaged, thereby allowing the belt, chain or gear wheel 53 to rotate backwards in relation to the input first shaft 54, while the second freewheel or anti-reverse mechanism 68 is locked, blocking the input first shaft 54 from rotating backwards, this combined operation locking the input first shaft completely from rotating. A return feeding electric motor 65 that is rigidly connected to said belt, chain or gear wheel 53 is during this phase continuously trying, using an adapted, sufficiently low torque, to rotate this belt, chain or gear wheel 53 in the reverse direction, this rotation being transferred to the anchor line 7 to keep it tensed during the sinking of the buoy 3. The return feeding electric motor is mounted to the support housing 43 in some suitable way, not shown. The electric motor 65 can be replaced by a power spring or any other type of elastic device, not shown, suitable for return feeding.

The input first shaft 54 thus extends into the gearbox assembly 41 in which it is coupled to an input side, the planet carrier or planet holder 66, of the planetary gearbox 58 through the first sliding clutch or similar device 67 and then through the second freewheel or anti-reverse mechanism 68. The clutch device 67 is used for disengaging the forward rotation caused by the rotation of the anchor drum 9 and thereby excessive energy in heavy sea conditions can be dissipated or prevented from being absorbed in order to protect the wave energy converter 1 from overloads. The clutch device for overload protection can be a suitable mechanical device commonly available for such purposes or it may be controlled by some supervising system, not shown. During normal operation the clutch device 67 is always engaged transferring the full torque. The rotor, not shown, of the generator 21 is, as indicated above, through the output third shaft 69 of the gearbox assembly 41 connected to the sun gear 70 of the planetary gearbox 58 whereas the belt, chain or gear wheel 59 included in the second belt, chain or gear drive 56 is mounted on the combined input/output second shaft 60 which is hollow, surrounding the output third shaft, and which is connected to the ring gear 57 of the planetary gearbox 58 as mentioned above.

This configuration gives a relatively stable torque acting on the shaft of the electric generator 21 and hence a relatively stable or constant rotational speed of the generator in the same way as the previous system layouts. The power output is controlled by adjusting the rotational speed of the generator 21 which can be done in several ways, such as by controlling the field current in the electrical windings in the generator. In this way the wave energy converter 1 can be tuned to match the average level of incoming wave energy by adjusting the state of equilibrium between the driving torque from the counterweight and the counteracting torque of the generator, thus controlling the rpm of the electric generator.

The anchor drum shaft 11′ and the counterweight drum shaft 11″ can be parallel to each other as illustrated and to the shafts 54, 60, 69 of the gearbox assembly 41. In the case illustrated in the figures the rotation axes of anchor drum shaft 11′ and the counterweight drum shaft 11″ are also located in the same, basically horizontal plane in the recess 45. The gearbox assembly 41 together with the generator 21 is as illustrated placed above the recess which houses the anchor drum 9 and the counterweight drum 15, and it is completely located inside the closed or encapsulated space 46 in the support housing 43. However, the shafts can be located in other positions, such position being generally allowed by the provision of the belt, chain or gear drives 51, 56. For example, the gearbox assembly 41 together with the generator 21 can be placed in the same horizontal plane as the anchor drum 9 and the counterweight drum 15 and then in a sealed or closed space, not shown, extending between the shaft support walls 44 and projecting downwards in the recess 45.

The gearbox assembly 41 forms a single module which can be easily replaced and it can include a gearbox housing or support 55. The gearbox housing or support can also enclose the second free-wheel or anti-reverse mechanism 68, the support 68′, which in this case can be attached to a wall of the gearbox housing or support 55, and, when provided, the clutch 67 for overload protection. The three shafts 54, 60, 69 of the gearbox assembly 41 project from opposite sides or ends of the gearbox housing 55. The gearbox housing is completely located in the sealed space 46. In the embodiment illustrated in FIGS. 1a-1d the gearbox assembly 41 and in particular the gearbox housing or support 55 is located in the upper space portion 46′, i.e. vertically above the recess 45 and the drums 9, 15. Suitable couplings, not shown, can be provided for releasing the module from its connection to the electric generator 21 and the return feeding electric motor 65.

The transmission layout of FIGS. 1a, 1b, 1c and 1d can have one or more of the following advantages.
1. The drums 9, 15 are firmly attached such as by welding to their respective shaft 11′, 11″, this requiring no special sealed bearings for their rotation around the driveshaft.
2. The portions 11′, 11″ of the driveshaft are relatively short and can thus handle larger torque in relation to the diameter, which may be important for the very heavy loads to which a wave energy converter of the kind described herein is exposed and the resulting very large torques on the driveshaft, and as a consequence they can have smaller diameters than in prior devices, this e.g. allowing a lower total weight of the driveshaft
3. The only bearings which are exposed to water are two bearings for each portion 11′, 11″ of the drive shaft.
4. The gearbox assembly is completely located in a sealed or closed space where the shafts thereof are supported by own bearings located in supports comprised in or attached to the support housing 43.
5. All free-wheel or anti-reverse mechanisms required are completely located in a sealed or closed space/sealed or closed spaces.
6. Belt, chain or gear drives or similar devices which are used are completely located in sealed or closed spaces.
7. The mechanism required for tensioning the anchor line is completely located in a sealed or closed space.
8. The transmission is more compact than prior devices.

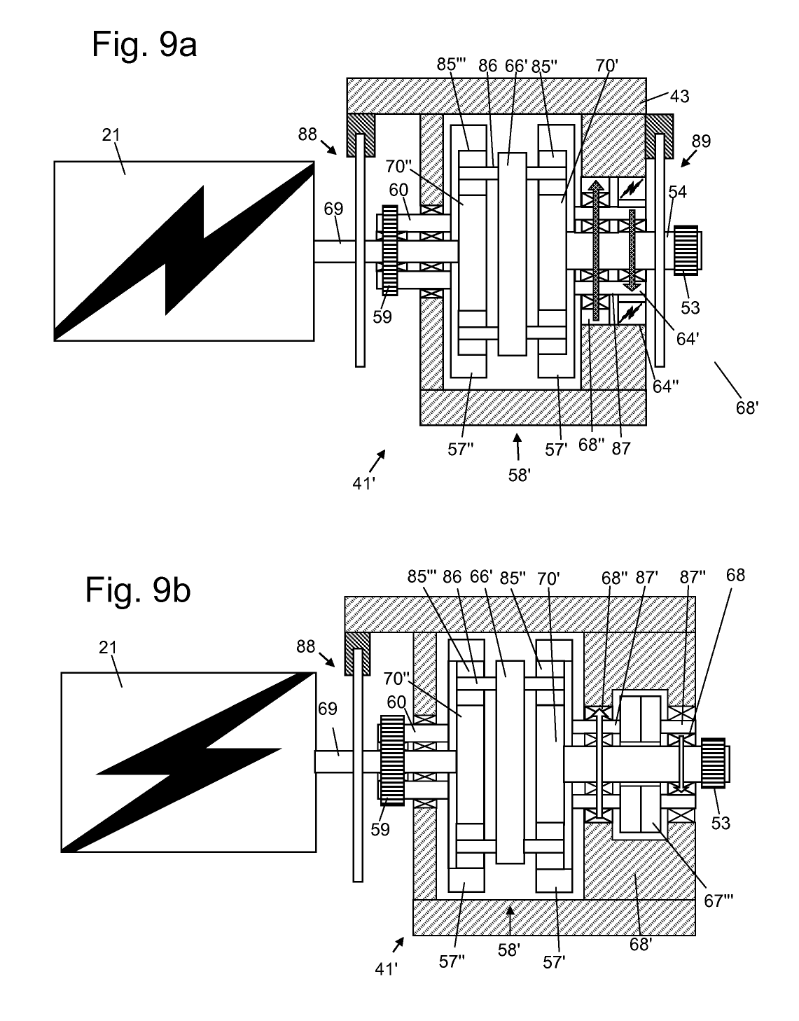

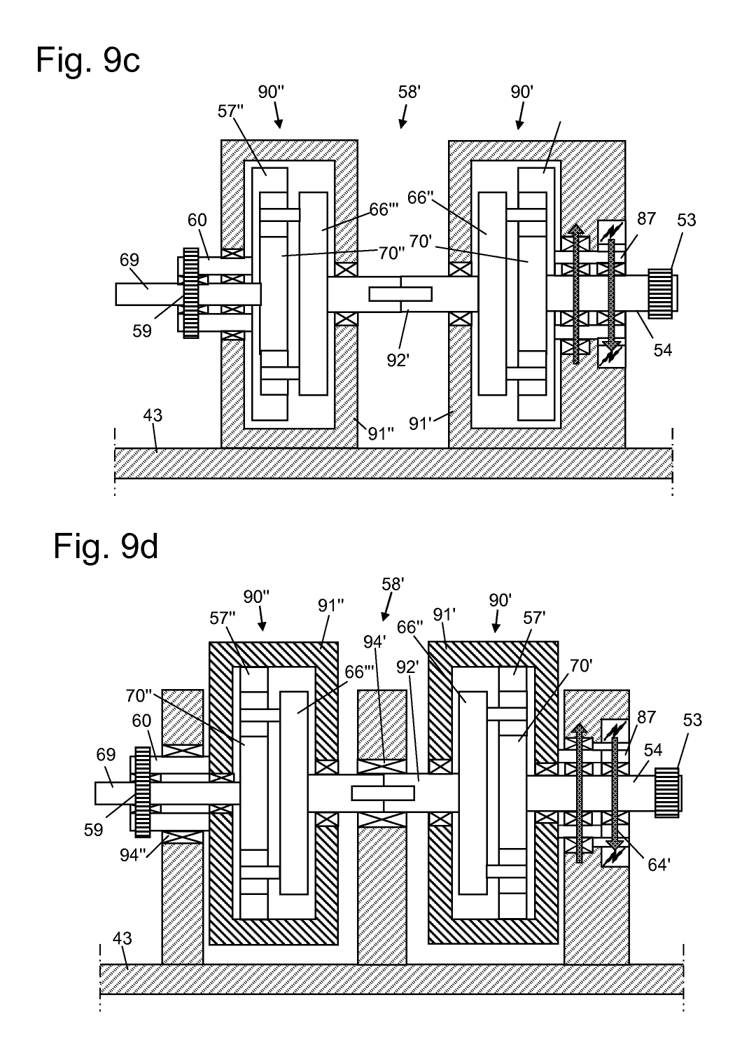

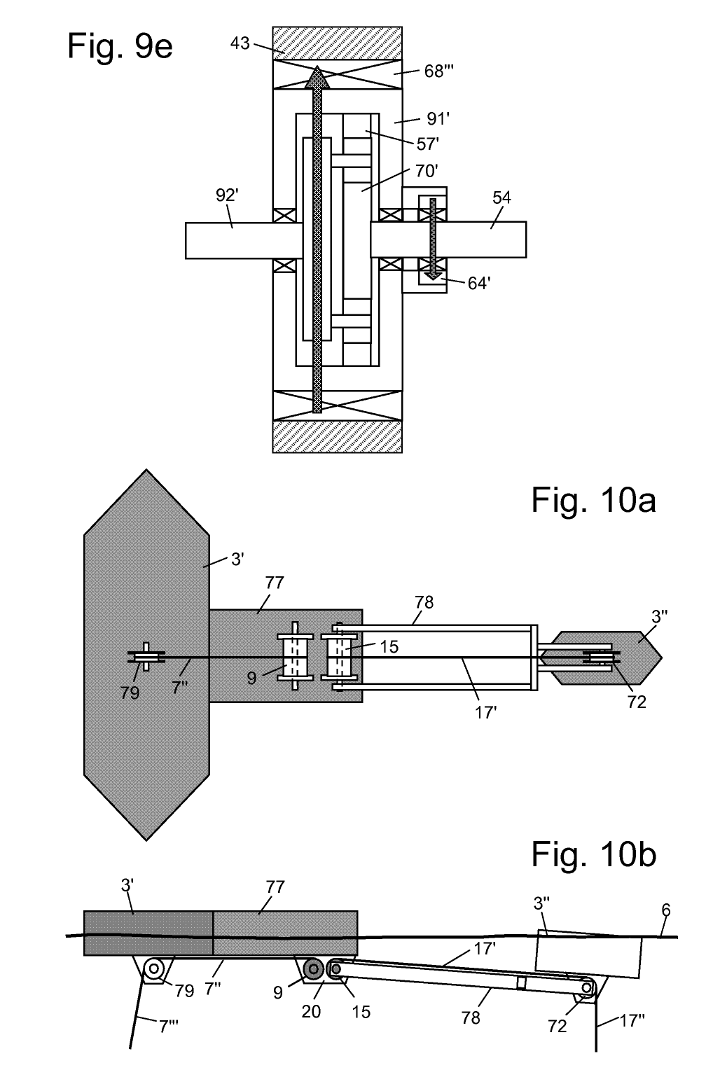

FIG. 9a is a sectional schematic view of a modified gearbox assembly 41′ having integrated forward- and return feeding capabilities. In the case where this modified gearbox assembly is used, the return feeding electric motor 65 is not required. The modified gearbox assembly 41′ also provides for unpowered disengagement of the system with a maintained return feeding force.

A special planetary gearbox 58′ is used in the modified gearbox assembly 41′. It comprises a single planet carrier 66′ that is centrally mounted in the gearbox and carries planet wheels 85″, 85′″ at the two opposite sides thereof. Each of the planet wheels 85″ at one side is mounted to rotate freely about a planet wheel shaft 86, that can be rigidly attached to the planet carrier 66′ and that at the opposite side of the planet carrier carries a planet wheel 85′″ which is also mounted to rotate freely about the planet wheel shaft 86. Furthermore, the special planetary gearbox 58′ comprises two ring gears 57′, 57″ and two sun gears 70′, 70″. A pair of one ring gear and one sun gear is mounted at each of the two sides of the planet carrier 66′, each pair being mirrored to each other. The planet wheels 85″, 85′″ on each side of the planet carrier are thus engaged with such a pair 57′, 70′ or 57″, 70″, respectively. The special planetary gearbox 58′ thus has two input/output shafts at each of its sides, one of the input/output shafts at each side thus rigidly attached to the sun gear 70′, 70″ at the same side and another of the input/output shafts at the same side rigidly attached to the ring gear 57′, 57″ at the same side.

As illustrated, the special planetary gearbox 58′ can be symmetrically designed having a symmetry plane located perpendicularly to the geometric axis of the gearbox and passing through the centrally mounted planet carrier 66′. Thus it can be considered to have a first stage at one side of the planet carrier and a second stage at the opposite side thereof, the second stage connected in a direction opposite that of the first stage, this being different from the structure of a conventional two-stage planetary gearbox. Generally, when transmitting force or torque through the special planetary gearbox from the input side thereof to the side connected at the electric generator 21, the force or torque first passes the sun gear 70′, then the central planetary carrier 66′ and finally the sun gear 70″. When considering the freewheels 64′ and 68″ to be described below, the special planetary 58′ gearbox gives a reduction of the rotation speed during the return feeding phase whereas the second stage gives an increased rotation speed. This means that the planet carrier 66′ is slowly rotating in a backward direction while the ring gear in the second stage in driving the sun gear 70′ in the second stage and thereby the electric generator 21. This is almost the same behaviour as in the embodiment comprising a single, ordinary planetary gearbox 58 in which the planet carrier 66 is still-standing in the return feeding phase.

At a first side or stage of the modified planetary gearbox 58′ the input shaft 54 connects as above the belt, chain or gear wheel 53 to the sun gear 70′ in this stage. Another shaft 87 that concentrically surrounds the first input shaft 54 is rigidly attached to the ring gear 57′ of the same stage and also forms an outer member, the first freewheel or antireverse mechanism 64′ acting between this outer member and the first input shaft 54 and the second freewheel or antireverse mechanism 68″ acting between this outer member and the support 68′ rigidly attached to the support housing 43. The two freewheel or antireverse mechanisms 64′, 68″ also act, in this case, in opposite directions, and the first freewheel or antireverse mechanism 64′ can be electromagnetically operated, as indicated at 64″, i.e. to allow disengagement between the outer member and the first input shaft 54 in both rotational directions. At the second side or stage of the modified planetary gearbox 58′ the two shafts are connected in a way similar to that described above. Hence, the sun gear 70″ of this stage is rigidly attached to the input shaft 69 of the electric generator 21 and the ring gear” 57″ is through the shaft 60 rigidly connected to the belt, chain or gear wheel 59 included in the second belt or drive 56 connecting the rotation of the counterweight drum 15 to the rotation of the electric generator.

In the normal mode, when the wave energy converter 1 is used for producing energy, the first freewheel or antireverse mechanism 64′ is enabled allowing it to provide its normal freewheeling operation. When the anchor drum 9 is rotated forward by a rising wave, the first freewheel or antireverse mechanism is thus locked. The input shaft 54 and hence the sun gear 70′ is then locked to the ring gear 57′ in the first stage of the special planetary gearbox 58′, this feeding or rotating the planet carrier 66′ in a forward direction with a 1:1 gear ratio in relation to the input shaft 54. The first stage of the special planetary gearbox 58′ is thus locked and the second stage thereof works in the same way as the planetary gearbox 58 described above, driving the generator 21 and also the counterweight drum 15, thereby lifting the counterweight 19.

When the wave is sinking, the rotational direction of the input shaft 54 is changed so that the second freewheel or antireverse mechanism 68″ acting between the support structure 43 and the ring gear 57′ at the same first side is locked while the first freewheel or antireverse mechanism 64′ acting between the input shaft 54 and the same ring gear 57′ is unlocked. The gear of the first stage in the special planetary gearbox 58′ is then activated so that the input shaft 54 has a higher rotation speed compared to that of the planet carrier 66′. The counterweight 19 drives the generator 21 via the second stage of the special planetary gearbox 58′. The planet carrier 66′ is then rotated in a backward direction opposite the forward direction obtained when the wave is rising. The rotation speed of the input shaft 54 is limited by the wave motion and the speed of the backward rotation of the planet carrier 66′ is reduced with the gear ratio compared to the rotation speed of the input shaft, e.g. a factor 1:10. The torque given by the counterweight 19 is as a consequence reduced by this gear ratio, allowing e.g. only 10% of the torque and thereby of the energy to be used for the return feeding. A higher gear ratio can be achieved by using additional gearing stages connected before the first stage in the special gearbox assembly 58′. A higher gear ratio reduces the return feeding force and thereby the energy used for the return feeding. If slack mooring is used as shown in FIG. 2c, the return feeding force can be lower, as typically achieved with a gear ratio of 50-100 in the first stage, using only 1-2% of the accumulated energy during return feeding.

The second stage of the modified gearbox 58′ is used for switching the drive between the anchor drum 9 and the counterweight 19. When the power of the forward feeding is greater than the energy produced by the generator 21, i.e. when the forward rotation speed of the anchor drum 9 is higher than the relative rotation speed between the planet carrier 66′ and the ring gear 57′ in the first stage of the special planetary gearbox, the ring gear 57″ in the second stage rotates in a first direction, lifting the counterweight 19 while limiting the torque on the generator 21 and transmission. When the power of the forward feeding is lower or when the transmission is in the return feeding stage, the ring gear 57″ in the second stage rotates in the second, opposite direction, using the energy stored in the counterweight 19 to drive the generator 21 with the same load, while a small part of the energy is used for return feeding, i.e. for rotating the input shaft in the opposite direction and thereby the anchor drum 9 in the direction opposite that obtained when the wave is rising.

In a disengaged mode used for a standby state and for storm protection, the first freewheel or antireverse mechanism 64′ between the input shaft 54 and the ring gear 57′ in the first transmission stage is disabled, i.e. it always allows rotation of the input shaft in both directions in relation to the ring gear 57′ of the first stage of the special planetary gearbox 58′. The ring gear of the first stage is thus not being driven to rotate by the input shaft 54 when the input shaft is rotating forwards, this causing the second freewheel or antireverse mechanism 68″ between the same ring gear 58′ and the support structure 43 to block this ring gear from being rotated backwards by the load from the counterweight 19, also during forward feeding. Thus, for both rotation directions of the anchor drum 9, the gear ratio of the first stage of the gearbox between the sun gear and the planet carrier is that which is obtained for a still-standing ring gear, this reducing the movement speed of the counterweight 19 with the same gear ratio while applying a constant return feeding force in the anchor line 7 through the whole wave cycle. This means that a direct link between the anchor line 7 and the counterweight line 17 is created without the need for electrical power to maintain tension of the anchor wire in the standby state. To prevent the counterweight 19 from losing altitude, the rotation of the generator 21 can be stopped by activating a disc brake 88 that can be mounted to the rotor shaft 69 of the generator, this disabling all power production.

In a spill mode the gearbox assembly 41′ alternates between the normal and the disengaged modes, i.e. the electrically operated first freewheel or anti-reverse mechanism 64′ is alternating between the state in which it is functional, allowing rotation in only one direction and the state in which it allows rotation in both directions. The disc brake 88 connected at the input side of the electric generator 21 is not engaged. When the counterweight 19 reaches a high position, the first freewheel or anti-reverse mechanism 64′ is electromagnetically operated to take a disabled state, this reducing the lift speed of the counterweight 19 and thereby the absorption of energy, while the electric generator 21 continues to produce power at the same level. This causes the counterweight 19 to fall to a lower position where the electromagnetically operated freewheel or anti-reverse mechanism 64′ is operated to be enabled again. The disengagement and engagement of the first freewheel or anti-reverse mechanism 64′ can be preferably done during the return feeding stage when the second freewheel or anti-reverse mechanism 68′ is unlocked and there is no torque transfer taking place over the second freewheel or anti-reverse mechanism 68′, in order to reduce the wear on the first freewheel or anti-reverse mechanism.

When doing service, the counterweight 19 has to be secured to the buoy 3. This can be done by a locking mechanism of a suitable kind, not shown. When the counterweight is securely attached to the buoy of the wave energy converter or to a service vessel, the electric generator 21 can be reversed to feed out line from both the counterweight drum 15 and anchor drum 9, which is necessary when e.g. replacing the gearbox housing 55.

A second disc brake 89 can be mounted to the input shaft 54. It is used to lock the anchor drum 9. To release the tension in the system, the counterweight 19 must also be secured and the electric generator 21 must be rotated to give slack.

Instead of the electrically operated first freewheel or anti-reverse mechanism 64′ at the input side a simple freewheel or anti-reverse mechanism can be used together with an electrically operated clutch 64′″. The function of the return feeding mechanism is the same. Such a design is illustrated in FIG. 9b where the outer shaft 87 that is connected to the ring gear 57′ is divided in a first part 87′ and a second part 87″, the two parts journalled for rotation in the support 68′. The first part 87′ is rigidly connected to the ring gear 57′. The first freewheel or anti-reverse mechanism 64 acts between the input shaft 54 and the second part 87″ of the outer shaft and the second freewheel or anti-reverse mechanism 68″ acts between the second part 87′ of the outer shaft and the support 68′, the first freewheel or anti-reverse mechanism allowing rotation in only one direction and the second freewheel or anti-reverse mechanism allowing rotation in only the opposite direction. The clutch 64′″ connects the two parts 87′, 87″ to each other to make them rotate as a single shaft when being suitably operated and otherwise allowing the two parts to rotate independently of each other.

In the normal mode, when the wave energy converter 1 is used for producing energy, the clutch 64′″ is always engaged connecting the two parts 87′, 87″ of the outer shaft 87 rigidly to each other. The function of the modified gearbox assembly 41′ is in this mode the same as that described with reference to FIG. 9a.

In the disengaged mode described above that is used in a standby state and for storm protection, here clutch 64′″ is disengaged, this disabling the operation of the first freewheel or antireverse mechanism 64′ and hence in this case also the function of the modified gearbox assembly 41′ is the same as described above with reference to FIG. 9a.

As in the embodiment of FIG. 9a, in the spill mode the modified gearbox assembly 41′ alternates between the normal and the disengaged modes but here the clutch 64′″ is alternating between its engaged and disengaged states, this giving the same function as that described above.

FIG. 9c is a schematic sectional view of another design of the special planetary gearbox 58′ for use in the modified gearbox assembly 41′. The special planetary gearbox is in this embodiment divided into two separate modules 90′, 90″ corresponding to the two stages of the special planetary gearbox 41′ as described above. Each of the two separate modules has a casing 91′, 91″ that is mounted to the support housing 43 and houses a freely rotating ring gear 57′, 57″. Each module is a complete planetary gearbox, the planet carriers 66″, 66′″ of which are rigidly connected to one another by an intermediate shaft 92′. The sun gear 70′ of the first module 90′ is rigidly connected to the input shaft 54 and the ring gear 57′ thereof is rigidly connected to the outer shaft 87. The sun gear 70″ of the second module 90′ is rigidly connected to the shaft 69 connected to the rotor of the electric generator 21 and the ring gear 57″ thereof is rigidly connected to the shaft 60 rotating outside the rotor shaft. This design gives the same function as that of the special planetary gearbox described above.

Still another embodiment of the special planetary gearbox 58′ is shown in the schematic sectional view of FIG. 9d. As in the embodiment of FIG. 9c the gearbox is divided into two separate modules 90′, 90″ that here can be standard planetary gearboxes, having their ring gears 57′, 57″ firmly mounted to their respective casings 91′, 91″ which here are freely rotating. The planet carriers 66″, 66′″ of the individual planetary gearboxes are rigidly connected to one another by an intermediate shaft 92′. Two extra bearings 94′, 94″ are required to support the shafts outside the element gearboxes 90′, 90″. The sun gears 70′, 70″ and the ring gears 57′, 57″ of the element gearboxes are mounted as in FIG. 9c. The electromagnetically operated first freewheel or antireverse mechanism 64′ that can also be called a first one-way clutch has as above two operational modes, an engaged mode where it works a regular one-way clutch and a disengaged mode where it does not transfer torque in any direction.

In FIG. 9e only the return feeding mechanism of the special planetary gearbox 58′ of FIG. 9d is shown, corresponding to the first stage of the special planetary gearbox. The mechanism shown is similar to the first standard module 90′ of this figure but the second freewheeling and antireverse mechanism 68″″ is here mounted between the general support housing 43 and a cylindrical outer surface of the rotatable casing 91′, the casing being as above secured to the ring gear 57′ of the first element gearbox 90′. When the input shaft 54 is rotated in a first direction, the first one-way clutch 64 locks the sun gear 70′ to the ring gear 57′. The second one-way clutch 68″″ is open, allowing the casing 91′ and the ring gear to rotate in the first direction in relation to the support housing 43. In this mode the gearbox stage acts as a stiff coupling having a gear ratio of 1:1. When the wave changes its direction, the input shaft 54 also changes its rotational direction. The intermediate shaft 92′ is then rotated in a second, opposite direction by the pull of the counterweight 19. When the casing 91′ and the ring gear 57′ reach the turning point, the second one-way clutch 68″″ locks the casing to the general support housing 43 and thereby the return feeding gear of the first stage is activated, i.e. the first one-way clutch 64′ is released allowing the sun gear 70′ to rotate in relation to the ring gear 57′. In this state the full gear ratio is applied between the input and output shafts 54, 92′ of the stage shown. In the figure only one gear step is shown, but as mentioned above more steps in the gear can be added to achieve a higher gear ratio. A high gear ratio gives low return feeding forces in the anchoring line 7 and thereby lower energy losses. Depending on the choice of anchoring system and conditions at the installation site, a certain force in the anchoring line is required. For example, if a constant tension mooring system is used, in which only the anchoring line maintains the position of the wave energy converter 1, a relatively high force or high tension in the anchoring line may be required. If a slack mooring system is used, in which the position of the wave energy converter is maintained by separate lines, slack mooring lines, a lower force or tension in the anchoring line is required.

Advantages of providing mechanical return feeding without using electric motors can include:
1. No electrical power is needed to return feed the anchor drum, this reduces the electrical losses in the system.
2. Tension of the anchor line 7 can be maintained also in standby mode without need for electrical power.
3. The risk of entanglement during standby due to slack in the anchor line is reduced
4. The anchor line is prevented from going from a slack to a tensioned state and thus sudden loads can be avoided.
5. Safety and redundancy are provided, keeping the device stationary in standby if the position moorings are damaged.

The alternative system or alternative wave power converter as described above can have one or more of the following advantages:
1. The planetary gearbox 58, 58′ is not located inside the counterweight drum 15. The drums 9, 15 have no delicate components mounted in their interiors and hence they can be firmly attached, e.g. be welded, to the anchor and counterweight shafts 11′, 11″, respectively. This decreases the amount of special scalings and bearings needed and simplifies the design.
2. The first transmission stage 51 is a belt or chain drive or similar device such as a gear drive, reducing the torque on the transmission components which significantly reduces the weight and size of these components.
3. The driveshaft 11 used in other layouts has been reduced in length and split up in shorter pieces. The link shaft has been removed. Only two bearing points are needed for each shaft portion 11′, 11″ and the weight and cost is significantly reduced for these components.
4. The transmission is more modularized and has a much smaller size compared to previously proposed system layouts, this making it easier to assemble, transport and service the transmission.

It has been found that the part of the anchor wire 7 where the bending of the anchor wire occurs in normal operation of the wave power plant, i.e. the part where the anchor wire is wound on to and unwound from the anchor drum 9, is exposed to heavy fatigue. As appears from FIGS. 1e and 1f, the system layout of the transmission or power takeoff 2 and the transmission housing 20 of FIGS. 1a, 1b and 1c can be modified to alleviate this problem. Thus, in the power takeoff the anchor wire 7 can be fed between parts of the anchor drum 9 or, more particularly, the portion of the anchor wire that is in normal operation wound around and unwound from the anchor drum to another portion of the anchor wire can be changed or shifted so that if it is expected that the used portion of the anchor wire has been exposed to sufficient fatigue, another portion of the anchor line can instead be used. Thus, by shifting the used portion of the anchor wire between the two parts of anchor drum 9, the worn out wire portion can be replaced with a fresh wire portion. This significantly extends the life of the anchor wire 7.

To achieve this, the original anchor drum 9 is divided into two drums that are placed coaxially at the sides of each other. A first anchor drum 9′ is firmly mounted to the anchor drive shaft 11′ and a second anchor drum 9″ is firmly mounted to another shaft 11′″. The latter shaft 11′″ is a hollow shaft that is mounted to rotate freely around the anchor drive shaft 11′. Each of these two shafts 11′, 11′″ is attached to a belt, chain or gear drive 51, 51′ that connects it to the first input shaft 54 of the gearbox assembly 41 through a first freewheel or antireverse mechanism 64, 64′″, respectively. Each of these belt, chain or gear drives can be in one or more steps though only one step is illustrated in the figure. In the illustrated embodiment the first belt, chain or gear drive 51 comprises as described above a teethed belt wheel 50 rigidly attached to the anchor drive shaft 11′, a teethed belt wheel 53 connected to the first freewheel 64 and a teethed belt 52 running around the belt wheels. The supplementary first belt, chain or gear drive 51′ comprises in a corresponding manner a teethed belt wheel 50′ rigidly attached to the another shaft 11′″, a teethed belt wheel 53′ connected to the first freewheel 64′″ and a teethed belt 52′ running around the belt wheels.

A braking or locking mechanism, not shown, for the another shaft 11′″, similar to the braking or locking device 49 for the anchor shaft 11′, can be arranged at the end of the another shaft that carries the belt wheel 50′.

A return feeding mechanism is arranged for each portion 9′, 9″ of the anchor drum. It comprises for each portion a return feeding electric motor 65, 65′ connected to the respective first freewheel 64, 64′″ through a belt, chain or gear drive 76, 76′. The return feeding electric motors are mounted to the support housing 43 in some suitable way, not shown. The belt, chain or gear drive 76, 76′ includes in the illustrated embodiment a teethed belt 85, 85′ running around a teethed wheel 98, 98′ rigidly attached to the shaft of the respective electric motor 65, 65′ and a teethed wheel 99, 99′ rigidly attached to the input side of the respective freewheel 64, 64′″. Each freewheel thus carries two teethed wheels on its input side, the teethed wheel 53, 53′ included in the respective belt, chain or gear drive 51, 51 connecting the respective anchor drive shaft 9′, 9″ to the first input shaft 54 of the gearbox assembly 41 and the teethed wheel 99, 99′ included in the belt drive 76, 76′ for return feeding, the teethed wheels 53, 99 and 53′, 99′, respectively, thus being rigidly connected to each other and rotating as one part.

The anchor line comprises a first part 7 that is attached to the bottom foundation 5 as described above and a second part 7′ at the power takeoff 2. One of the ends of the second part is attached to the first anchor drum 9′ and the other end of the second part 7′ is attached to the second anchor drum 9″. Thereby only portions of the second part 7′ is wound on to and unwound from the two anchor drums when the wave power plant is operating. Thus, the second part 7′ of the anchor line forms a loop between the two anchor drums 9′, 9″. The first part 7 and the second part 7′ of the anchor line are connected by a sheave 100 that is attached to rotate at the upper end of the bottom, first part 7 of the anchor line, the second part of the anchor line running around the sheave.

During normal operation, when the wave rises, the first freewheels 64, 64′″ are locked to the first input shaft 54 of the gearbox assembly 41 and rotate it forwards. When the wave goes down, the two return feeding electric motors 65, 65′ rotate simultaneously, thereby rotating, through the belt, chain or gear drives 76, 51, and 76′, 51, respectively, the anchor drums 9′, 9″ backwards, winding the respective portion of the second part 7′ of the anchor line around the corresponding anchor drum 9′, 9″ to keep the anchor wire parts 7, 7′ sufficiently tensed. During normal operation the system works in the same way as with the layout described above. The two anchor drums 9′, 9″ always rotate synchronously with each other.

Wire shifting can be performed during the return feeding simply by making one of the return feeding motors 65, 65′ rotate faster than the other one. This causes wire to shift from the slower rotating drum 9′ or 9″ to the faster rotating drum 9″ or 9′, respectively.

Using line shifting as described herein, the wire can be dimensioned for a relative short length of life, typically 6 months before the wire is discarded. A portion of approximately 3 meters of the wire is exposed to the most heavy wear, depending on the wave climate. Hence, every 6 months, 3 meters of the wire has to be fed from one drum to the other until all the wire 7′ has been used, at which point the transmission housing 20 and the wire arrangement must be detached from the buoy 3 and transported to shore for wire replacement and other service operations. Instead of shifting 3 meters of wire every 6 months, a smaller portion of the wire can be shifted more often.

The wire shifting technique described with reference to FIGS. 1e and 1f can be used in a similar manner together with the mechanical return feeding mechanism described with reference to FIGS. 9a-9f, see in particular FIG. 9b, such a structure not requiring electrical motors for return feeding. Thus, as shown in FIG. 1g, the teethed wheel 53 in the first belt, chain or gear drive 51 is rigidly attached to the input first shaft 54 of the gearbox assembly 41, the respective first freewheel 64 thus omitted. The teethed wheel 53′ in the supplementary belt, chain or gear drive 51′ for the hollow, another anchor drum shaft 11′″ is as above connected to the first freewheel 64′ for the supplementary drive. This first freewheel 64′ is connected to the input first shaft 54 in such a way that it is locked during forward feeding. A disc brake 89′ is attached to the input side of the freewheel 64′ provided for the supplementary belt, chain or gear drive 51′.

During normal operation, the disc brake 89′ is disengaged and the first belt, chain or gear drives 53, 53′ rotate synchronously in both forward and reverse directions of the input first shaft 54. Wire shifting is achieved by locking the disk brake 89′ during return feeding, thus blocking the attached second anchor drum 9″ from rotating in the return feeding direction. The counterweight 19 is now linked only to the first anchor drum 9′, causing this drum to rotate faster, thus shifting wire from the second anchor drum 9″ to the first anchor drum 9′.

The wire shifting technique described with reference to FIGS. 1e, 1f and 1g can be used in a similar manner also for the counterweight drum 15 and the counterweight line 17. Thus, as shown in FIG. 1h, the counterweight drum is divided into two drums that are placed coaxially at the sides of each other. A first counterweight drum 15′ is rigidly attached to the counterweight drive shaft 11″ and a second counterweight drum 15″ is rigidly attached to a hollow shaft 11″″ that is mounted to rotate freely around the counterweight drive shaft 11″. These two shafts 11″, 11″″ are connected to the second belt, chain or gear drive 56 and a supplementary second belt, chain or gear drive 56′, respectively. Each of these belt, chain or gear drives can be in one or more steps though only one step is illustrated. The second belt, chain or gear drive 56 comprises as described above a teethed wheel 62 rigidly attached to the counterweight drive shaft 11′, a teethed wheel 59 rigidly attached to input/output second shaft 60 and a teethed belt 61 running around the teethed wheels. The supplementary second belt, chain or gear drive 56′ comprises a teethed wheel 62′ rigidly attached to the other, hollow drive shaft 11″″, a teethed wheel 59′ connected to a freewheel 59″ and a teethed belt 52′ running around the teethed wheels. This freewheel acts between the teethed wheel 59′ and the input/output second shaft 60 and is connected in such a way that it is locked when a disc brake 89″ is disengaged. The disc brake 89″ is attached to the input side of the freewheel 59″ provided for the supplementary belt, chain or gear drive 56′.

During normal operation, the disc brake 89″ is disengaged and the second belt, chain or gear drives 59, 59′ thus rotate synchronously in both forward and reverse directions of the input/output second shaft 60. Wire shifting is achieved by engaging the disc brake 89″ when the counterweight shaft 11′ is rotating in the opposite direction to the direction of the torque given by counterweight 19, thereby causing the freewheel 59″ to unlock and thereby reduce the rotation speed of the second counterweight drum 15″. The first counterweight drum 15′ thus rotates faster, causing wire to be shifted from the second counterweight drum 15″ to the first counterweight drum 15′.

The above described wire shifting mechanism for the counterweight drum 15 can of course also be used in combination with the ordinary gearbox assembly 41 of FIGS. 1a-1f.

A wire shifting mechanism as described herein can have the following advantages:
It can significantly extend the life of the respective line or wire 7, 17 and thus the service interval, which in turn reduces the maintenance cost.
It allows smaller drums and lines or wires having smaller diameters to be used without limiting the life of the lines or wires, which in turn reduces the input torque in the system.
It allows fully automatic wire shifting that can be performed during normal operation of the wave power plant without reducing the power output.

It is obvious that the embodiment described including a split anchor drum 9′, 9″ as described above can be used in general mooring or anchoring systems in order to reduce the wear on the mooring or anchoring lines. Then the belt, chain or gear drives 53, 76 and 53′, 76′ can be combined into one belt, chain or gear drive, not shown, or the return feeding motors 65, 65′ can be directly connected, this arrangement not shown, to the respective part of the anchor drum.

Generally, a wire shifting mechanism such as that described above can be used in every system which includes a winding drum and a line, wire or cable or similar flexible means, herein called line, that when the system is in use is partly wound around the winding drum and alternately is being unwound therefrom and being wound up thereabout. One example of such a mechanism is seen in the principle view of FIG. 1i. As described above with reference to FIG. 1e, the winding drum is divided in two winding drums and the line, not shown in FIG. 1i, comprises a first distant part that e.g. can be attached to a load or similar device or bottom foundation as described above and a proximate part. One of the ends of the proximate part is attached to the first winding drum 15′ and the other end of the proximate part is attached to the second winding drum 15″. Thereby, only portions of the proximate part is wound on to and unwound from the two anchor drums when the wave power plant is operating. The proximate part of the line forms a loop between the two winding drums 15′, 15″. The two parts of the line are interconnected by a sheave that is attached to rotate at the upper end of the distant part of the line, the proximate part of the line running around the sheave.

The first winding drum 15′ is rigidly attached to an inner shaft 11″ and the second winding drum 15″ is rigidly attached to an outer, hollow shaft 11″″ that is mounted to rotate freely around the inner shaft 11″. One of these two shafts 11″, 11″″, in the drawing the outer shaft through a teethed wheel 62′, called the driven shaft, is connected to a tensing or driving device, not shown, for rotating the respective shaft. The outer, hollow shaft 11″″ is connected to the inner shaft through a freewheel or anti-reverse mechanism 12. Hence, when the driven shaft is driven to rotate in a first direction, the other, undriven shaft can rotate synchronously with the driven shaft, which is the case if the line is connected to a load, or it can possibly rotate faster than the driven shaft in the same direction. When the driven shaft is driven to rotate in a second, opposite direction, the other shaft will be allowed to rotate freely in the first direction and to rotate with a speed equal to or lower than that of the driven shaft in the second direction. A disc brake 63 is attached to the other, undriven shaft, in the figure the inner shaft 11″″.

During normal operation when the line is subject to a load, the disc brake 63 is disengaged and the two shafts 11″, 11″″ can then rotate synchronously in both directions. Wire shifting is achieved by engaging the disc brake 63 when driven shaft is rotating in the direction which is opposite the direction of the torque produced by the load attached to the line, thereby causing the freewheel 63 to unlock and thereby reduce the rotation speed of undriven shaft and the winding drum attached thereto. The winding drum attached to the driven shaft will then rotate faster, causing line to be shifted from the undriven winding drum to the driven drum.

Instead of the freewheel or anti-reverse mechanism 12 any coupling device can used that can provide that same function, e.g. a clutch that is remotely controlled. Other arrangements are also possible, e.g. both of the shafts can be driven by own tensing or driving device.

The transmission layouts described above can be used in the configuration shown in FIGS. 2a and 2b. In this configuration the buoy 3 is a combination of two buoys, a front buoy 3′ and a rear boy 3″ that are rigidly connected to each other by an intermediate part 71. The element buoys can as illustrated have a substantially cylindrical shape, e.g. a circular-cylindrical shape, and the front buoy can have a larger buoyancy or displacement than the rear buoy, i.e. it has larger capacity of carrying other components. Thus, the front buoy 3′ can have a diameter, taken horizontally, that is larger than that of the rear buoy 3″, the ratio of the diameters e.g. being in the range of 3:2, and the height, i.e. the vertical dimension of the buoys can be substantially equal to each other. The front buoy 3′ carries the transmission housing 20 and the rear buoy 3″ carries the counterweight 19, not seen in these figures, suspended in the in the counterweight line 17. The rear buoy carries a sheave or break wheel 72 so that there is one portion 17′ of the counterweight line which extends substantially horizontally from the counterweight drum 15 in the transmission housing to the sheave or break wheel, i.e. from the rear buoy 3″ to the front buoy 3′, and another portion 17″ which extends, generally in a substantially vertical direction, from the sheave or break wheel to the counterweight. Hence, there can be a considerable distance horizontally between the counterweight 19 and the mooring or anchor line 7, ensuring that the counterweight line 17 and the anchoring line 7 are not easily entangled with one another. This design provides a stable positioning of the combined buoy 3′, 3″ towards the wave direction and is also more sensitive in mild waves, i.e. it starts to move more easily, since the weight of the front buoy is lower than that of the total buoy.

The schematic of FIG. 2c shows a configuration using slack moorings to secure the horizontal position of the wave energy converter 1 while allowing some degree of freedom. Mooring lines 73 are at one end connected to the buoy 3′ and 3″, respectively, of the wave energy converter and at their other end to the bottom 8, e.g. to bottom foundations 74. Typically two mooring lines are connected to the front buoy 3′ and one mooring line to the rear buoy 3″. This significantly reduces the force that is otherwise needed by the return feeding motor 65 to keep the line or lines sufficiently tense and thereby maintain the position of the wave energy converter 1. The slack mooring also prevents the combined buoy 3′, 3″ from turning around while allowing it to follow the wave direction within an angular interval, simplifying the electrical cable connection. The electrical power cable, not shown, can for example extend down to the bottom together with one of the mooring lines 73. This configuration is especially favorable in geographical areas where there is a main direction of major waves such as close to coast lines. In this configuration also additional buoys 75 can be provided for lifting the mooring lines 73 so that they have portions 73′ which extend horizontally from the buoy 3′, 3″ to the respective additional buoy and another portions 73″ which extend from the additional hub buoy to the bottom 8. Hence, the buoys 3′ and 3″ are only influenced by horizontal forces, this giving a greater freedom of movement and allowing a smoother operation.

In the case where additional position mooring buoys 75 are used, an electrical power cable, not shown, can in another case extend from one of the part buoys 3′, 3″ to one of the additional position mooring buoys 75 and therefrom to a power hub or power buoy, not shown, located at the water surface 6.

FIGS. 10a and 10b are schematic views of a buoy layout that can further smoothen the power output and limit the maximum torque in the transmission. In this embodiment also the structural forces between the front and counterweight buoys 3′, 3″ can be reduced.

The front buoy 3′ is wider than that of the embodiment of FIGS. 2a-2c in order to increase the response to small waves and comprises a wider front part 77 and a more narrow rear part 77′. The front part can e.g. as illustrated have the shape of a hexagon, seen from above, the hexagon having two opposite parallel longer sides and four shorter sides located for example in angles of 45° to the two long sides. The rear part 77′ can have rectangular shape seen from above as shown. The transmission housing 20 is directly attached to or constitutes the rear part 77′ of the front buoy 3′. The front buoy also carries, at the front portion thereof, a sheave or break wheel 79 so that there is one portion 7″ of the anchor line 7 which extends substantially horizontally from the anchor drum 9 in the transmission housing 20 to the sheave or break wheel, i.e. beneath the front buoy 3′, and another portion 7′″ which extends, generally in a substantially vertical direction, from the sheave or break wheel to the bottom foundation 5. The sheave or break wheel 79 decreases the force needed for the line tracking device and minimizes the wear on the line. The transmission housing 20 can be dimensioned to have closed spaces of a sufficient total volume so that it can carry its own weight including the transmission components in the same way as in the embodiment of FIGS. 2a-2c.

The counterweight buoy 3″ is connected to the front buoy 3′ via an intermediate part 78 that is hinged at its front end to the transmission housing 20, this allowing the rear buoy to move freely in a vertical direction while being fixed in the horizontal plane in relation to the front buoy, enabling directional properties. The intermediate part 78 can be designed as a fork at one of or both of its ends. E.g. it can have a fork shape at its front end, being there hinged to rotate about the same rotation axis as the counterweight drum 15. The intermediate part 78 is at its rear end rigidly attached to the counterweight buoy. The rear buoy 3″ is made smaller, having a limited carrying capability, so that the maximum load from the counterweight 19 is limited. A 5 ton counterweight would e.g. be carried by a rear buoy 3″ limited to carrying a maximum of approximately 5.5 tons, i.e. the carrying capability of the rear buoy exceeds the weight of the counterweight by only a small amount, e.g. not more than about 10%. When a wave lifts the buoy 3″ the increased force in the counterweight line 17″ will pull the counterweight buoy 3″ to a position below the water surface 6, this limiting the torque in the system. When the wave turns, the reduced force in the counterweight line portion 17″ will allow the counterweight buoy 3″ to rise to the water surface again. The hinged fork can of course also be used in combination with a larger buoy where it is used for reducing the forces on the structure. The distance between the buoys 3′, 3″ causes a phase shift between the movements of the front and rear buoy that also decreases the movement of the counterweight. The movement of the counterweight 19 is lowest when the distance between the element buoys 3′, 3″ corresponds to half the wave length of the water movements.

The transmission housing 20 and the anchor sheave or break wheel 79 of the front buoy 3′ can be both attached to a frame, not shown, attached to or being part of the support housing 20 that supports the load between the anchor sheave or break wheel or the anchor drum 9 and comprises a beam that is firmly fixed to the front buoy and to the transmission housing. The structural strength is improved when mounting the transmission housing.

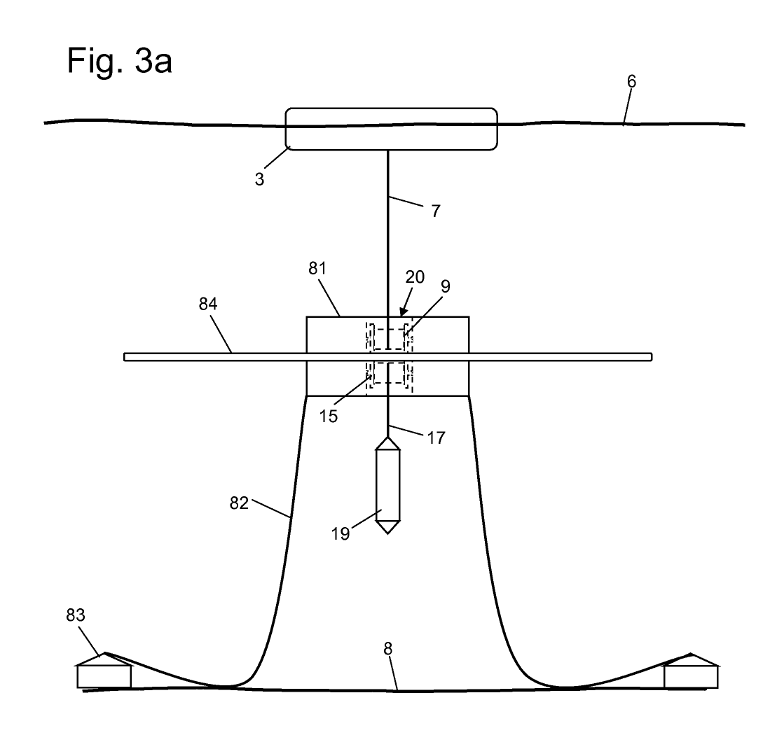

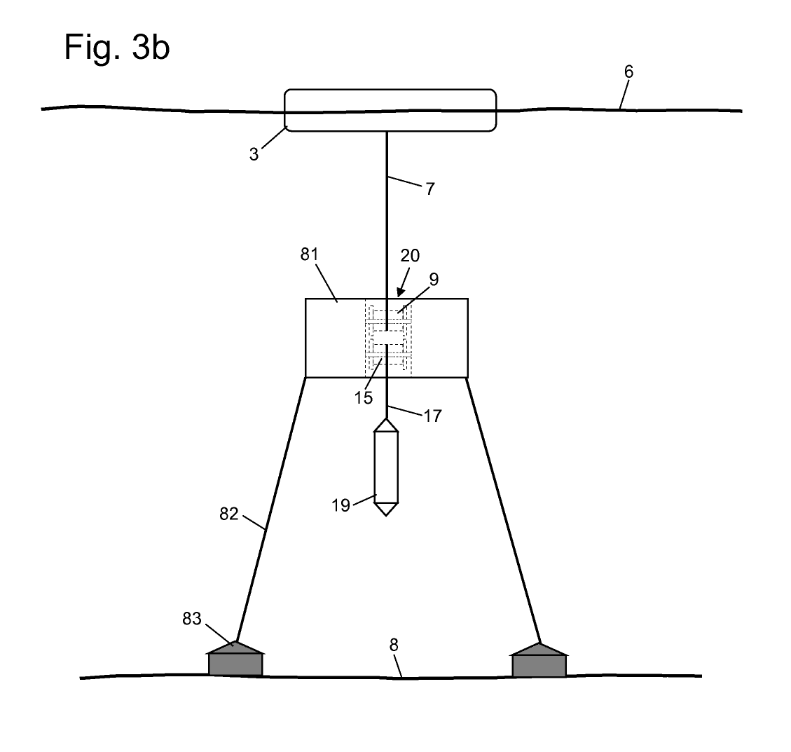

In the design of FIG. 3a a submerged body 81 is used in which a transmission housing of any suitable design such as any of those shown in FIGS. 1a, 1b and 1c and in the cited International Patent Application No. WO 2009/105011. The submerged body may in one case have a relatively large mass, compare FIGS. 7d and 10a of the cited patent application and the description of these figures. However, in the case illustrated the submerged body 81 includes a heave plate 84 that creates a force counteracting the wave motion and in particular it does not follow the motion of waves at the water surface 6. The wave energy is captured by a separate buoy 3 at the water surface 6. The buoy can generally be smaller than the submerged body and it may have a symmetric shape so that it does not have to follow the wave directions. The submerged body 81 is slack moored to the seafloor 8, using a mooring system normally having two or more mooring lines 82 and bottom foundations 83. This allows the system to work efficiently also at greater water depths. Winding drums, not shown, for the mooring lines 82 comprise line tracking devices mooring so that the lines are wound correctly independently of the drift direction of the buoy 3. The line tracking devices are known technology. The depth of the submerged body 81 beneath the floating body 3 can be tuned by changing the buoyancy of the submerged body using ballast tanks, not shown, and/or by changing the return feeding force on the buoy drum, the buoy drum corresponding to the anchor drum 9 described above and the buoy line 7 corresponding to the anchor line. Such ballast tanks can also allow the submerged body 81 to be elevated to the water surface 6 for service and maintenance. Electrical power cables, not shown, can follow the slack mooring lines 82 to the sea floor 8 without the need for a slip ring or similar device.

The design of FIG. 3b is similar to that of FIG. 3a but tensed mooring lines 82 are used to fix the submerged body 81 carrying the transmission housing 20 in a vertical direction. A heave plate 84 may not be used for this design. This is a simpler solution that can be used in shallower water. Since the vertical position is firmly fixed the performance in smaller waves can be increased. The mooring system has also in this case normally two or more mooring lines 82 and bottom foundations 83.

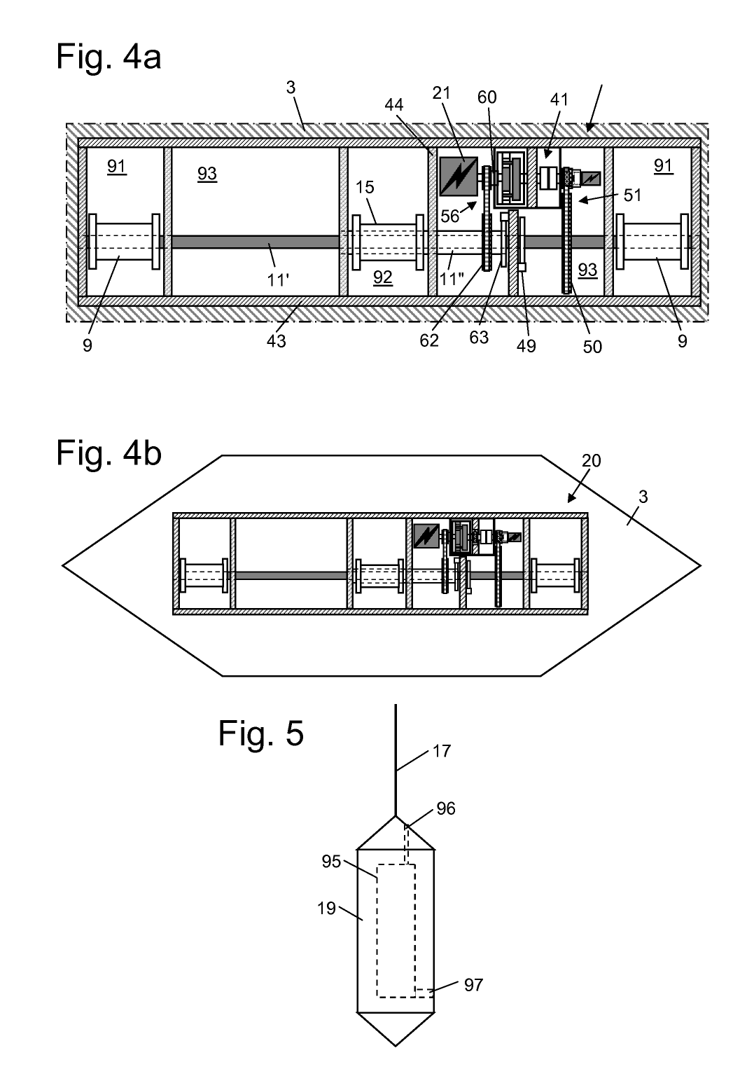

The gearbox assembly 41 together with the generator 21 described with reference to FIGS. 1a, 1b, 1c and 1d can also be used in a configuration where the two portions of the driveshaft 11, the 15 anchor drum shaft 11′ and the counterweight shaft 11″ are coaxially and concentrically mounted as illustrated in FIG. 4a, the counterweight shaft then e.g. enclosing a region or segment of the anchor drum shaft. In the embodiment of FIG. 4a two anchor drums 9 are used which then may placed at opposite ends of the transmission housing 20 or support housing 43 that as illustrated can be rather elongated, not having the compact layout of FIGS. 1a-1d. A long anchor drum shaft 11′ stiffly connects the two anchor drums 9 to each other and extends through a hollow counterweight shaft 11″, the counterweight drum 15 being located between the two anchor drums 9. Shafts supports 44 extend between two long opposite sides of the support frame 43 of the support structure 41. The counterweight shaft is thus mounted for rotation around the anchor drum shaft but can still be mounted for rotation in sealed bearings, not shown, in the shaft supports. The shaft supports 44 define in this case three open spaces 91, 92 and two closed or sealed spaces 93, these two closed or sealed spaces located between adjacent ones of the three open spaces. The counterweight drum 15 is located in the central open space 92 and the anchor drums 9 in the other two open spaces 91 located at the sides of the central open space but separated therefrom by the closed or sealed spaces 93. The gearbox assembly 41 together with the generator 21 and the belt, chain or gear drives 51, 56 are located in one of the closed spaces 93, the hollow counterweight drum shaft 11″ extending also into this space and there carrying the belt, chain or gear wheel 62 of the second belt, chain or gear drive 56. As above, the first belt, chain or gear drive 51 connects the rotation of the anchor drum shaft 11′ to the rotation of the first input shaft of the gearbox assembly 41 and the second belt, chain or gear drive 56 connects the rotation of the counterweight drum shaft 11″ to the second input shaft 60 of the gearbox assembly 41.

A transmission housing 20 having such a configuration and similar ones can be used in a single buoy design as shown in FIG. 4b. The buoy 3 has in this design an elongated shape, as seen in a vertical direction, the various axes of the power train 2 being parallel to the longitudinal direction. For example, the buoy can have a shape including a long rectangular central portion and shorter end portions that are round or triangular as illustrated. With this design the buoy 3 can be turned with one of its long sides towards the wave direction, allowing the buoy to absorb more energy, in particular in mild wave climates.

As seen in FIG. 5, a counterweight 19 for a general wave energy converter, such as the wave energy converter described with reference to FIGS. 8a-8d, can be equipped with a ballast tank 95. The ballast tank is used for tuning the weight of the counterweight which may be used for setting the sensitivity of the wave energy converter 1. A light weight in mild waves allows a better heave response which gives a higher power output. A rubber tube or similar device is connected to the air intake 96 which is used to set the desired air volume. When the air volume is decreased, water enters the ballast tank 95 through the water intake 97, and vice versa.

While specific embodiments of the invention have been illustrated and described herein, it is realized that numerous other embodiments may be envisaged and that numerous additional advantages, modifications and changes will readily occur to those skilled in the art without departing from the spirit and scope of the invention. Therefore, the invention in its broader aspects is not limited to the specific details, representative devices and illustrated examples shown and described herein. Accordingly, various modifications may be made without departing from the spirit or scope of the general inventive concept as defined by the appended claims and their equivalents. It is therefore to be understood that the appended claims are intended to cover all such modifications and changes as fall within a true spirit and scope of the invention. Numerous other embodiments may be envisaged without departing from the spirit and scope of the invention.

### LIST OF REFERENCE NUMERALS

1 wave energy converter
2 power train or power takeoff
3 buoy or floating body
3′ front buoy
3″ rear boy or counterweight buoy rigidly connected to front buoy 3′ by intermediate part 71
5 bottom foundation
6 surface of pool of water
7 anchor line or first part of anchor line attached to bottom foundation 5
7′ second part of anchor line at anchor drum running over sheave 100
7″ portion of the anchor line 7 that extends substantially horizontally
7′″ portion of the anchor line 7 that extends substantially vertically
8 bottom of pool of water
9 first winding drum, anchor drum
9′ first anchor drum
9″ second anchor drum
11 driveshaft
11′ first part, anchor drum shaft, of driveshaft 11
11″ second part, counterweight drum shaft, of drive shaft 11 or inner shaft
11′″ hollow shaft mounted to rotate around anchor drum shaft 11′
11″″ hollow shaft mounted to rotate around counterweight drum shaft 11″ or outer shaft mounted to rotate around inner shaft 11″
12 freewheel or anti-reverse mechanism mounted to act between inner shaft 11″ and outer shaft 11″″
13 support bars attached to walls of transmission housing 20
15 second winding drum, counterweight drum
15′ first counterweight drum or first winding drum
15″ second counterweight drum or second winding drum
17 counterweight line
17′ portion of counterweight line 17 that extends substantially horizontally
17″ portion of counterweight line 17 that extends substantially vertically
18 gear transmission coupling rotation of anchor drum 9 to rotation of counterweight drum 15
19 counterweight
20 transmission housing or power train room
21 electric generator, generator of electric power
31 bearings supporting input shaft 54 of gearbox assembly 41 and mounted in support walls 33
32 bearings supporting input/output shaft 69 of gearbox assembly 41 and mounted in support walls 33
33 shaft support walls attached to support housing 43 carrying bearings 31, 32
34 wall forming roof of recess or space 45 and connecting opposite shaft support walls 33 to another
41 gearbox assembly
41′ modified gearbox assembly having integrated forward- and return feeding capabilities
43 support housing or support frame
44 two parallel shaft support walls or shaft supports extending between two opposite outer walls of surrounding support housing 43
45 central recess or central open space formed in support housing 43 and open downwards
46 closed or sealed inner space defined in support housing 43
46′ upper portion of closed or sealed inner space 46
47′ first side space of closed or sealed inner space 46 and located interior of and laterally of one of shaft support walls 44
47″ second side space of closed or sealed inner space 46 and located interior of and laterally of one of shaft support walls 44
48 two bearings for rotation of anchor drum shaft 11′ in shaft supports 44
48′ two bearings for rotation of counterweight drum shaft 11″ in shaft supports 44
49 disc brake or drum brake or other braking or locking mechanism for locking anchor drum shaft during e.g. service
50 belt, chain or gear wheel in first belt, chain or gear drive 51 and attached to anchor drum shaft 11′
50′ belt, chain or gear wheel in first belt, chain or gear drive 51′ and attached to hollow, another anchor drum shaft 11′″
51 first belt, chain or gear drive including belt, chain or gear wheel 50 and belt, chain or gear 52 and belt, chain or gear wheel 53
51′ supplementary first belt, chain or gear drive for hollow, another anchor drum shaft 11′″ in wire shifting mechanism
51 belt, chain or gear in first belt, chain or gear drive 51
52′ belt, chain or gear in supplementary first belt, chain or gear drive 51′ for hollow, another anchor drum shaft 11′″
53 belt, chain or gear wheel in first belt, chain or gear drive 51 connected to input first shaft 54
53′ belt, chain or gear wheel in supplementary first belt, chain or gear drive 51′ for hollow, another anchor drum shaft 11′″
53″ return blocking mechanisms blocking driveshaft 11 from rotating backwards
54 input first shaft of gearbox assembly 41
54′ anti-reverse mechanism
55 gearbox housing or gearbox support
56 second belt, chain or gear drive including belt, chain or gear wheel 59, belt, chain or gear 61 and belt, chain or gear wheel 62
56′ supplementary second belt, chain or gear drive for hollow, another counterweight drum shaft 11′″ in wire shifting mechanism
57 ring gear of planetary gearbox 58
57′ ring gear in special planetary gearbox 58′
57″ ring gear in special planetary gearbox 58′
58 planetary gearbox
58′ special planetary gearbox including single planet carrier 66′ centrally mounted in gearbox and planet wheels 85′, 85″ at opposite sides thereof
59 belt, chain or gear wheel in second belt, chain or gear drive 56 and attached to input/output second shaft 60
59′ belt, chain or gear wheel in supplementary first belt, chain or gear drive 56′ for hollow, another anchor drum shaft 11′″
59″ freewheel or anti-reverse mechanism mounted to act between belt, chain or gear wheel 59′ and input/output second shaft 60 of gearbox assembly 58′
60 input/output second shaft of gearbox assembly 41, hollow and rigidly connected to ring gear 57 of planetary gearbox 58 and to belt, chain or gear wheel 59 included in second belt, chain or gear drive 56
61 belt, chain or gear in second belt, chain or gear drive 56
61′ belt, chain or gear in supplementary first belt, chain or gear drive 51′ for hollow, another counterweight drum shaft 11″″
62 belt, chain or gear wheel in second belt, chain or gear drive 56 and attached to counterweight drum shaft 11″
62′ belt, chain or gear wheel in second supplementary first belt, chain or gear drive 56′ and attached to hollow, another counterweight drum shaft 11″″
63 disc brake or drum brake or other braking or locking mechanism for locking counterweight drum shaft during e.g. service
64 first freewheel or first anti-reverse mechanism, also called first one-way clutch, mounted to act between belt, chain or gear wheel 53 and input first shaft 54 of gearbox assembly 41
64′ electromagnetically operated first freewheel or first antireverse mechanism for special planetary gearbox 58′
64″ electromagnetic operation of first freewheel or first antireverse mechanism 64′ for special planetary gearbox 58′
64′″ first freewheel or first antireverse mechanism coupled to belt, chain or gear drive 51′
65 return feeding electric motor rigidly connected to belt, chain or gear wheel 53
65′ return feeding electric motor rigidly connected to belt, chain or gear wheel 53′
66 planet carrier or holder of planetary gearbox 58
66′ single planet carrier centrally mounted in special planetary gearbox 58′ and having planet wheels 85′, 85″ at its two opposite sides
66″ planet carrier mounted in first module or element gearbox 90′ of special planetary gearbox 58′
66′″ planet carrier mounted in second module or element gearbox 90″ of special planetary gearbox 58′
67 sliding clutch or similar device in input first shaft 54
68 second freewheel or second anti-reverse mechanism mounted, also called second one-way clutch, to act between support 68′ rigidly attached to support housing 43 and input first shaft 54 or between second part of outer shaft 87′ and input first shaft
68′ support rigidly attached to wall 34 or support housing 43
68″ second freewheel or second antireverse mechanism, also called second one-way clutch, for special planetary gearbox 58′
68′″ second freewheel or second antireverse mechanism, also called second one-way clutch, for special planetary gearbox 58′ mounted between casing of first stage and support frame
69 output third shaft connecting rotor of electric generator 21 to sun gear 70 of planetary gearbox 58
70 sun gear of planetary gearbox 58
70′ sun gear in special planetary gearbox 58′
70″ sun gear in special planetary gearbox 58′
71 intermediate part rigidly connecting front buoy 3′ and rear boy 3″ to each other
72 sheave or break wheel carried by rear buoy 3″
73 mooring lines at one end connected to element buoys 3′ and 3″
73′ portions of mooring lines 73 which extend horizontally from buoy 3′, 3″ to the respective additional buoy 75
73″ portions of mooring lines 73 which extend from additional hub buoy 75 to bottom 8
74 bottom foundations for mooring lines 73
75 additional buoys for lifting mooring lines 73
75 belt, chain or gear drive for return feeding electric motor 65
76′ belt, chain or gear drive for return feeding electric motor 65′
77 front wider part of front buoy 3′
77′ rear part of front buoy 3′ carrying transmission housing 20
78 intermediate part connecting counterweight buoy 3″ to front buoy 3′
79 sheave or break wheel carried by front buoy 3′
80 main frame
81 submerged body
82 two or more mooring lines
83 bottom foundations for mooring lines 82
84 heave plate
85 teethed belt in belt, chain or gear drive 76 for return feeding motor 65
85′ teethed belt in belt, chain or gear drive 76′ for return feeding motor 65′
85″ 85′″ planet wheels at the two opposite sides of single planet carrier 66′ centrally mounted in special planetary gearbox 58′
86 planet wheel shaft in special planetary gearbox 58′
87 hollow or outer shaft concentrically surrounding first input shaft 54 and rigidly attached to ring gear 57′ of first stage of special planetary gearbox 58′
87′ first part of hollow or outer shaft 87
87″ second part of hollow or outer shaft 87
88 disc brake mounted to rotor shaft 69 of electric generator 21
89 second disc brake mounted to input first shaft 54
89′ disc brake mounted to first freewheel or anti-reverse mechanism 64′ for supplementary belt, chain or gear drive 51′
89″ disc brake mounted to freewheel or anti-reverse mechanism 59″ for supplementary belt, chain or gear drive 56′
90′ first module or element gearbox of special planetary gearbox 58′
90″ second module or element gearbox of special planetary gearbox 58′
91′ casing of module 90′ mounted to support housing 43
91″ casings of module 90″ mounted to support housing 43
92′ intermediate shaft rigidly connecting planet carriers 66′, 66″ of modules 90′, 90″ to one another
91 open space or recess at ends of support housing 43
92 central open space or recess in support housing 43
93 two closed or sealed spaces between open spaces in support housing 43
94′ extra bearing supporting shaft between element gearboxes 90′, 90″
94″ extra bearings supporting shaft outside second element gearbox 90″
95 ballast tank of counterweight 19
96 air intake for ballast tank 95
98 teethed wheel in belt, chain or gear drive 76
98′ teethed wheel in belt, chain or gear drive 76′
99 teethed wheel in belt, chain or gear drive 76
99′ teethed wheel in belt, chain or gear drive 76′
100 sheave interconnecting first part 7 and second part 7′ of anchor line
111 arrows showing absorption of wave energy
113 arrows
115 arrows
117 arrows showing reverse feeding of anchor drum 9 when buoy 3 is sinking

1. A wave energy converter including:
a driveshaft portion mounted to be rotated for movements of the water when the wave energy converter is arranged for use in a pool of water,
an electric generator,
an energy accumulation device,
a three-way gearbox, in particular a planetary gearbox, that is mounted in a transmission path between the driveshaft portion, the electric generator and the energy accumulation device and that comprises a first gearbox shaft, a second gearbox shaft and a third gearbox shaft, the gearbox shafts arranged at two opposite sides or ends of the three-way gearbox, and
the driveshaft portion coupled to the first gearbox shaft, the energy accumulation device coupled to the third gearbox shaft and the electric generator coupled to the second gearbox shaft, wherein the couplings to the gearbox shafts are arranged so that at least the three-way gearbox and the electric generator are located in a stationary, sealed and closed space and/or so that the three-way gearbox and the electric generator are located at a radial distance of the driveshaft portion.

2. A wave energy converter according to claim 1, wherein the coupling of the driveshaft portion to the first gearbox shaft is arranged at a first side or end of the three-way gearbox and the coupling of the energy accumulation device portion to the second gearbox shaft is arranged at an opposite, second side or end of the three-way gearbox.

3. A wave energy converter according to claim 1, wherein the coupling of the driveshaft portion to the first gearbox shaft comprises a first belt, chain or gear drive and that the coupling of the energy accumulation device portion to the second gearbox shaft comprises a second belt, chain or gear drive, the first belt, chain or gear drive arranged at a first side or end of the three-way gearbox and the second belt, chain or gear drive arranged at an opposite, second side or end of the three-way gearbox.

4. A wave energy converter according to claim 1, wherein a first portion of the driveshaft is coupled to the first gearbox shaft and a second portion of the driveshaft is coupled to the second gearbox shaft, the first and second portions of the driveshaft in particular being mounted at a radial distance of each other.

5. A wave energy converter according to claim 4, wherein said first and second portions extend between two opposite parallel shaft support walls, a central open space being defined between the two shaft supports and inner closed or sealed spaces being defined behind the opposite sides of the shaft support walls.

6. A wave energy converter according to claim 1, wherein the three-way gearbox is comprised in a gearbox assembly also comprising one or more anti-reverse mechanisms.

7. A wave energy converter according to claim 1, wherein the three-way gearbox is comprised in a gearbox assembly also comprising a sliding clutch for overload protection.

8. A wave energy converter according to claim 1, wherein a first portion of the driveshaft that is coupled to the first gearbox shaft and a second portion of the driveshaft that is coupled to the second gearbox are coaxially or concentrically mounted, the second portion being hollow and enclosing a region of the first portion.

9. A transmission or gearbox assembly for a wave energy converter comprising a planetary gearbox, wherein the planetary gearbox includes two stages each including a pair of a sun gear and a ring gear, the two pairs sharing a central planet carrier having planet wheels at each of the its two sides cooperating with the respective pair or the two stages including individual planet carriers that are rigidly connected to each other.

10. A transmission or gearbox assembly according to claim 9, wherein each of the two stages include a separate gearbox module, the planet carriers of the two gearbox modules rigidly connected to each other by an intermediate shaft.

11. A transmission or gearbox assembly according to claim 10, wherein the ring gear of each of the two stages is rigidly connected to a casing mounted to rotate freely.

12. A transmission or gearbox assembly according to claim 10, wherein the ring gear of each of the two stages is mounted to rotate freely in relation to a stationary casing.

13. A transmission or gearbox assembly according to claim 12, wherein an input shaft rigidly attached to the sun gear of the first stage, a hollow shaft surrounding or enclosing a portion of the input shaft, the hollow shaft being attached to drive the ring gear of the first stage and an anti-reverse mechanism mounted to act between the input shaft and the hollow shaft.

14. A transmission or gearbox assembly according to claim 13, wherein a clutch mounted between portions of the hollow shaft.

15. A transmission or gearbox assembly according to claim 12, wherein an input shaft rigidly attached to the sun gear of the first stage and an anti-reverse mechanism mounted to act between a stationary support frame of the transmission or gearbox assembly and the ring gear of the first stage.

16. A wave energy converter including:
a buoy arranged at or in a pool of water to be set into motion by movements of the water in the pool of water,
a driveshaft, which is rotatably mounted to the buoy or the other device, respectively, or to a device arranged to give a force counteracting the movements of the water in the pool of water,
a first elongated means, which both is coupled to a device arranged to give a force counteracting the movements of the water in the pool of water or to the buoy, respectively, and is coupled to the driveshaft,
an electric generator, which is coupled to the driveshaft and includes two parts that are rotatable in relation to each other, a first part and a second part, and
an energy accumulation device including a counterweight and coupled to the driveshaft, characterized in that the buoy includes a front element buoy and a rear element buoy connected to each other, the first elongated means extending from the front element buoy and the counterweight being suspended from the rear element buoy.

17. A wave energy converter according to claim 16, wherein the counterweight is suspended in a counterweight line, the counterweight line extending from the counterweight over a sheave or break wheel rotatably mounted in the rear element buoy and therefrom to the front element buoy.

18. A wave energy converter according to claim 16, wherein the front and rear element buoys are rigidly connected to each other.

19. A wave energy converter according to claim 16, characterized in that the rear element buoy is hinged to the front element buoy allowing the rear element buoy to move in a vertical direction in relation to the front buoy but being maintained from moving in a horizontal direction in relation to the front buoy.

20. A wave energy converter according to claim 19, wherein the first elongated means comprises an anchor line, the anchor line extending from the drive shaft over a sheave or break wheel rotatably mounted in the front element buoy in front of the drive shaft and therefrom extending to the bottom of the pool of water.

21. A system including a winding drum and a line that when the system is in use is partly wound around the winding drum and alternately is being unwound therefrom and being wound up thereabout, in particular a mooring or anchoring system for a buoy or other device arranged at or in a pool of water and set into motion by movements of the water in the pool of water, in particular the buoy of a wave energy converter, or a counterweight system of a wave energy converter, wherein:
the winding drum comprises two parts that are arranged to rotate independently of each other,
the line comprises:
an upper part, end portions of which are more or less wound around a separate one of the two parts of the winding drum,
a bottom part attached or secured to the bottom of the pool of water, and
a running sheave attached to the upper end of the bottom part of the line, the upper part of the line running over the sheave, and
a line shifting mechanism is provided, the line shifting mechanism connected to the two parts of the winding drum allowing in a first state the two parts of the winding drum to rotate synchronously, locked for rotation to each other, and in a second state that the two parts of the a winding drum are unlocked for rotation in relation to each other, so that line that is wound around one of the parts of the winding drum is allowed to be shifted therefrom to the other part of winding drum.

22. A system according to claim 21, wherein the wire shifting mechanism is comprised in or part of a return feeding mechanism coupled to the line for keeping it tensed.

23. A system according to claim 21, wherein the two parts of the winding drum are connected to the same driving shaft and in the first state locked thereto and in the second state, one of the two pails of the winding drum being releasable therefrom, in particular being locked from rotating.

24. A system according to claim 21, each of the two parts of the winding drum is coupled to an own tensing or return feeding motor.

25. A system according to claim 21, wherein the two parts of the winding drum are coaxially mounted, a first part mounted to a first shaft and second part mounted to a second hollow shaft arranged to rotate around a portion of the first shaft.

26. A system according to claim 21, wherein the two parts of the winding drum are coaxially mounted, a first part mounted to a first shaft and second part mounted to a second hollow shaft arranged to rotate around a portion of the first shaft.
